(19) United States
(12) Patent Application Publication
(10) Pub. No.: US 2010/0153277 A1
(43) Pub. Date: Jun. 17, 2010

(54) SYSTEM AND METHOD FOR NETWORK-BASED ELECTRONIC TRADING PLATFORM FOR GOODS

(76) Inventor: Gang YU, Shang Hai City (CN)

Correspondence Address: MCDERMOTT WILL & EMERY LLP, 600 13TH STREET, N.W., WASHINGTON, DC, 20005-3096, US

(21) Appl. No.: 12/436,494

(22) Filed: May 6, 2009

(30) Foreign Application Priority Data
Dec. 17, 2008 (CN) 200810204789.7

(51) Int. Cl. G06Q 30/00; G06Q 10/00

(52) U.S. Cl. 705/80

(57) ABSTRACT

A method is provided for facilitating a seller to trade goods with a buyer via a network-based electronic trading platform. The method includes facilitating a platform operator and a seller customer to enter into a first agreement to enable the platform operator to purchase the goods via a first member; assigning the property ownership of the purchased goods to the platform operator and a right to trade the purchased goods to the first member; enabling a buyer customer to buy the certain quantity of the goods from the platform operator via a second member; and assigning a right to buy the certain quantity of the goods to the second member. The method also includes performing a third action facilitating the platform operator to sell the certain quantity of the goods to the buyer customer based on the second agreement.

### BACKGROUND

1. Technical Field

The present teaching relates generally to method and system for Internet applications. Specifically, the present teaching relates to method and system for Internet based online trading platform for goods.

2. Discussion of Related Art

With the advancement of the Internet, more and more trades are conducted via e-Commerce over the Internet. For example, eBay provides a platform where a consumer seller and a consumer buyer can trade their goods. Certain credit evaluation scheme is provided by eBay with respect to both sellers and buyers. What eBay provided is a trading platform where sellers and buyers can enter into trading agreement directly without any intermediary parties. Through such a platform, a seller who wants to sell a product and a buyer who desires to buy a similar product has to know each other's needs directly via the platform.

There exists other forms of trading in the commercial world. Some are more complex than simple seller-buyer direct dealings. For example, goods can be purchased by a party without the actual need for the goods and can be further traded not for actual need for the goods but for a pure financial interest for a gain computed based on a price difference in the trading. Property rights in goods may be separate from the right to trade goods so that transfer of rights to trade can be conducted without changing hands in terms of property rights. When the Internet based e-Commerce is becoming more and more ubiquitous, there is a need to facilitate other more complex trading schemes via Internet technology.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 depicts an exemplary construct of a system diagram for a network based trading platform for goods, according to an embodiment of the present teaching;

FIG. 2 depicts a system configuration where a customer utilizes an electronic trading platform to trade goods via a member of a platform operator, according to an embodiment of the present teaching;

FIG. 3 describes a more detailed relationship among a customer, a member, and an electronic trading platform, according to an embodiment of the present teaching;

FIG. 4(a)-4(c) provide exemplary system configurations of a network-based electronic trading system, according to embodiments of the present teaching;

FIG. 5(a) depicts an exemplary construct of an electronic trading platform, according to an embodiment of the present teaching;

FIG. 5(b) shows an exemplary construct of a trading control platform, according to an embodiment of the present teaching;

FIG. 6 shows an exemplary construct of a strategy support system, according to an embodiment of the present teaching;

FIG. 7 shows an exemplary construct of a logistic support system, according to an embodiment of the present teaching;

FIG. 8 shows an exemplary construct of an index support system, according to an embodiment of the present teaching;

FIG. 9 shows an exemplary construct of a service support system, according to an embodiment of the present teaching;

FIG. 10 illustrates exemplary trading relationships among members of a platform operator, according to an embodiment of the present teaching;

FIG. 11 shows an exemplary construct of an exchange support system, according to an embodiment of the present teaching;

FIG. 12 illustrates exemplary trade transfer forms, according to an embodiment of the present teaching;

FIG. 13 shows an exemplary construct of a transformation support system, according to an embodiment of the present teaching;

FIG. 14 is a flowchart of an exemplary process for a transaction between a seller customer and a platform operator, according to an embodiment of the present teaching;

FIG. 15 is a flowchart of an exemplary process for a transaction between a buyer customer and the platform operator, according to an embodiment of the present teaching;

FIG. 16 illustrates the flow of achieving a bilateral transaction of goods via forward sale through two separate trades on an electronic trading platform, according to an embodiment of the present teaching;

FIG. 17 is a flowchart of an exemplary process of trading via a forward sale agreement using an electronic trading platform, according to an embodiment of the present teaching;

FIGS. 18(a) and 18(b) is a flowchart of an exemplary process in which a sale of goods is accomplished via two separate trades, according to an embodiment of the present teaching;

FIG. 19 illustrates exemplary types of scores/points that may be accumulated within an electronic trading platform, according to an embodiment of the present teaching;

FIG. 20 illustrates exemplary types of considerations when scores/points based on forward sale agreements are accumulated, according to an embodiment of the present teaching;

FIG. 21 illustrates exemplary types of considerations when membership based scores are to be accumulated, according to an embodiment of the present teaching;

FIG. 22 illustrates exemplary types of credits that can be accumulated, according to an exemplary embodiment of the present teaching

FIG. 23 presents exemplary types of considerations that may contribute to an evaluation of member credits, according to an embodiment of the present teaching; and

FIG. 24 presents exemplary types of considerations that may contribute to an evaluation of customer credits, according to an embodiment of the present teaching.

### DETAILED DESCRIPTION

The present teaching is for providing a network-based electronic trading platform for goods. Within the electronic trading platform, rights to the goods being traded and the right to trade the goods are separated and assigned to different parties. The right to the goods belongs to the platform operator who runs the network-based electronic trading platform. The right to trade the goods belongs to members of the platform operator. Sellers and buyers of goods achieve trading of their goods via members of the platform operator. Members of the platform operator represent end customers, who are either sellers or buyers of goods that are being traded via the platform. A sale between a seller customer and a buyer customer is achieved through at least two separate trades, one from the seller to the platform operator, via a first member, and the other is from the platform operator to the buyer, via another member. Independent of the trading activity for goods, members of the platform operator may also trade their rights to trade the goods with each other for a gain. Compensation of members of the platform operator can be realized through both trading goods and trading their rights to trade goods. More detailed descriptions related to exemplary implementation of the network-based electronic trading platform is provided below with reference to different figures.

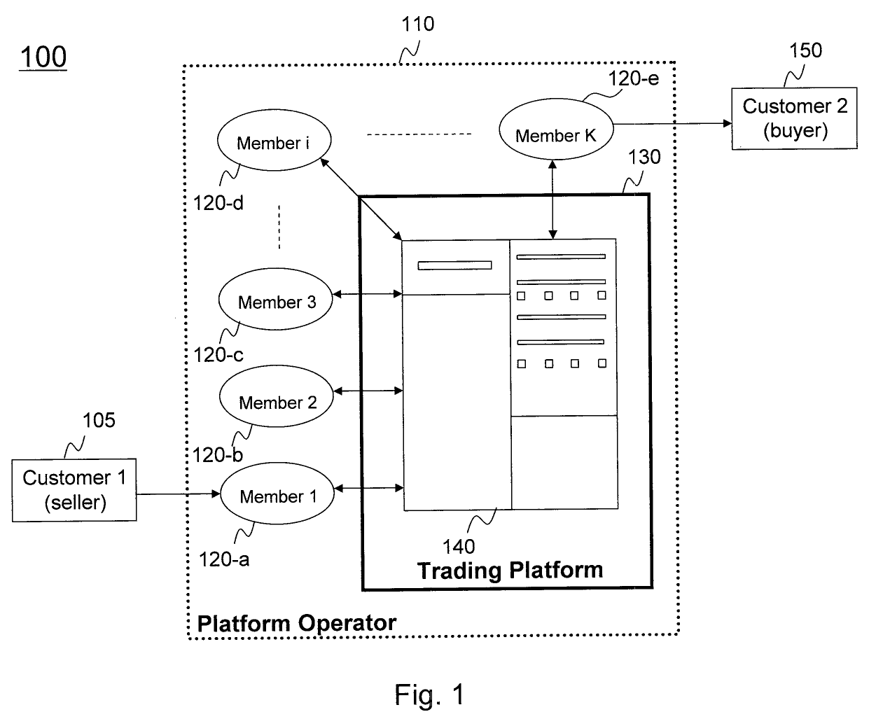

FIG. 1 depicts an exemplary system diagram 100 for the network based trading platform for goods, according to an embodiment of the present teaching. In this exemplary configuration, the system 100 comprises an exemplary customer 1 (seller) 105, a platform operator 110, and a customer 2 (buyer) 150. The seller customer 105 can sell goods through the platform operator 110 to a buyer, which can be illustrated via the buyer customer 150. To facilitate the sale, the platform operator 110 runs an operational system including an electronic trading platform 140 and one or more members such as member 1 120-a, member 2 120-b, member 3 120-c, . . . , member i 120-d, . . . and member K 120-e. Both the seller customer 105 and the buyer customer 150 are associated with some members of the platform operator 110 and customers trade only through members of the platform operator 110.

Goods traded through the electronic trading platform 140 can be any tangible goods such as steel, coals, cement, etc. A seller customer can be any party who has goods in hand and desires to sell the goods to some other party. For example, a seller customer can be a steel manufacturer or a coal producer. A seller customer can also be a party who, although not a manufacturer of the goods, owns the goods and desires to sell the goods. A buyer customer can be any party who has the need for certain goods. A buyer customer does not have to be a party who actually consumes the goods.

A member of the platform operator 110 can be any party who desires to receive compensation by conducting successful trading activities, whether goods or rights to trade goods, based on the electronic trading platform 140. Each member can have an association with one or more customers, sellers or buyers, to assist the customers to achieve their goals in trading goods via the electronic trading platform 140. The customers associated with each member may be determined in various ways. For example, the platform operator 110 may assign a certain number of customers to each member. Such assignment may be based on the past record of, e.g., how well the member helped a particular customer. Each member may also bring in their own customers to the platform operator 110. Such initial association with customers may also be subject to change based on, e.g., whether the member served the customer's need well.

With respect to each customer, an associated member has the right to trade the underlying goods based on the interests of their customers. For example, if a member is associated with a seller customer who has goods to sell, the member associated with this seller customer possesses the right to trade the goods, i.e., to sell the goods for the customer. As another example, if a member is associated with a buyer customer who desires to purchase goods, the member associated with this buyer customer possesses the right to buy the desired goods, i.e., to purchase the goods for the customer. In addition to the right to trade goods for customers, each member is also allowed to trade such rights with each other. Therefore, there can be two separate tracks of trading under the system 100: one is the track of trading goods on behalf of customers (as detailed below) and the other is the track of trading their rights to trade goods for their customers.

Both tracks of trading activities are for gains to the members. For example, there can be a gain to a member who sells/buys goods for his customers. In addition, this member can also transfer his right to trade for his customers to another member and receives a fee for the transfer. The total compensation to the member can be the sum of both types of trades.

The electronic trading platform 140 facilitates a successful trade of goods between a seller customer, such as customer 105, and a buyer customer, such as customer 150, by conducting at least two separate trades or deals. One is between the seller customer 105 and the platform operator 110 via a member, e.g., member 120-a, and the other is between the platform operator 110 and the buyer customer 150, via a different member, e.g., member K 120-e. Through the first trade, the platform operator 110 buys goods from the seller customer 105 with a certain quantity. With the second trade, the platform operator 110 sells at least a part of the purchased goods to a buyer customer such as 150.

Between the first and the second trade, there can also be other trading activities between members and such intermediary trades may involve only their rights to trade goods. For instance, after member 1 120-a completes the trade of a certain quantity of goods at a particular price between the seller customer 105 and the platform operator 110, member 120-a may transfer his right to trade either the full or a partial quantity of the goods to, e.g., member 3 120-c for a gain. Subsequently, member 3 120-c may further transfer the right to trade to, e.g., member K 120-e, also for a gain. The right to be transferred may not be the right to trade the full quantity of the goods. That is, it is possible to trade the right to trade associated with only a part of the goods that a member initiating the transfer has. During these transactions, the gain at each trade may be positive or negative to the party who initiates the trade.

The computation of the gain yielded during a transfer of right of trading goods may be based on a difference in the prices of the goods for which the right to trade is exchanged. For instance, if the price for the goods purchased via member 1 120-a is P and then member 1 transfers his right to trade the goods to member 3 120-c at a price PI higher than P, there may be a gain to member 1 120-a computed based on the difference between P and P1. That gain may be paid by member 3 120-c to member 1 120-a.

The system 100 also facilitates the conversion from a forward sale to a sale with actual goods. A forward sale refers to a sale for anticipated goods (good not yet available but that will be at some point of time in the future). For example, a sale agreement for selling 1,000 tons of steel each month for the next 12 months is a forward sale agreement. A sale with actual goods refers to a sale of real goods that are already available. For instance, a seller customer may want to sell 1,000 tons of steel that is already produced and available. Under the system 100, the first trade entered into between the seller customer 105 and the platform operator 110 via member 1 120-a may involve either a forward sale or a sale for actual goods. Similarly, the second trade (that achieves the sale from the seller customer to the buyer customer) entered into between the platform operator 110 and the buyer customer 150 via member K 120-e may involve either a sale for actual goods or a forward sale. When the first trade and the second trade involve different types of sales, a conversion occurs. For instance, if the first trade involves a forward sale and the second trade involves a sale for actual goods, a conversion occurs.

The electronic trading platform 140 enables that conversion in a seamless and coherent manner on the same platform. When the platform operator 110 and the seller customer 105 enter into a forward sale agreement, when goods are produced at the anticipated time as specified in the forward sale agreement, the goods made may be delivered to a destination specified by the platform operator 110 (owner of the property right of the goods) and now the delivered quantity becomes actual goods and can be traded as actual goods through a sale agreement for actual goods. The conversion may be significant because it may affect how a member who holds the right to trade the underlying goods of a forward sale agreement is to be evaluated for compensation. Detailed discussion related to this subject is provided herein below.

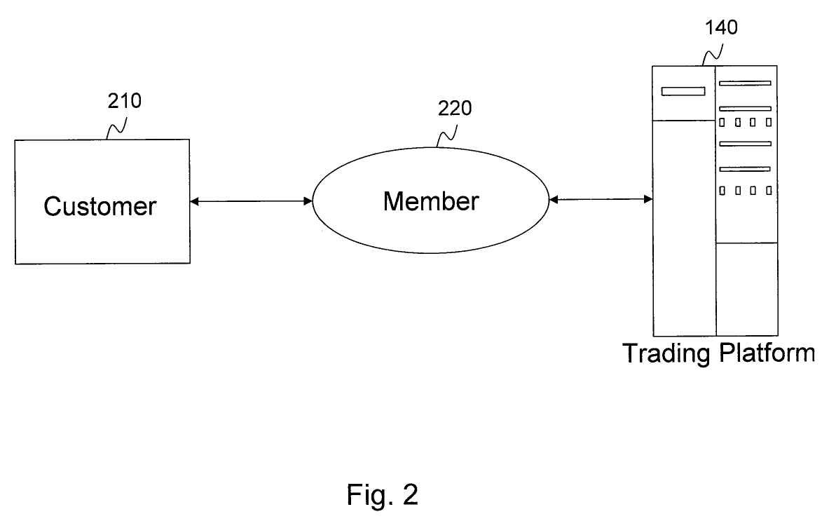

FIG. 2 depicts a system configuration where customers are utilizing the electronic trading platform 140 to trade goods via members of the platform operator 110, according to an embodiment of the present teaching. Each interaction between a customer 210 and the trading platform 140 is single directional, either from a seller customer (210) to the platform or from the platform to a buyer customer (210). Thus, for two customers (one seller and one buyer) to complete an actual trade with each other, there are at least two single directional trades, one from a customer (seller) to the trading platform 140 and the other from the trading platform 140 to a customer (buyer). Each direction is via a member, as shown in FIG. 2.

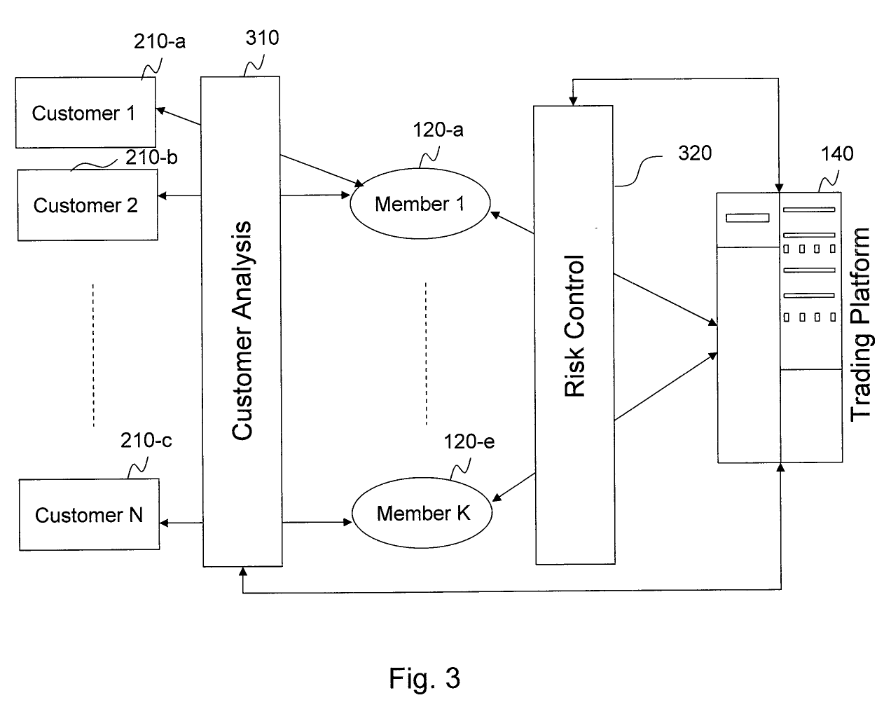

FIG. 3 describes a more detailed relationship among a customer, a member, and an electronic trading platform 140, according to an embodiment of the present teaching. A plurality of customers, e.g., 210-a . . . 210-b, may be associated with a single member, e.g., 120-a. When there is a plurality of members, each member may associate with one or more customers, acting on behalf of the platform operator 110 to trade goods related to the one or more customers. When a member conducts trading on behalf of the platform operator 110, certain risk control (320) may be exercised over the member via the trading platform 140, as shown in FIG. 3. For example, if a member is about to enter into an agreement with a customer with certain terms, the trading platform 140 may perform a credit check on either the customer or the member or both to ensure that the trade to be accomplished is reasonable given the credit of both parties. On the other hand, to ensure effective trade, appropriate customers may be assigned to certain members. For instance, a member with expertise in a particular type of steel may be assigned to work with customers who either produce that type of steel or customers who have a need for that type of steel. This is achieved by the trading platform 140 via customer analysis 310.

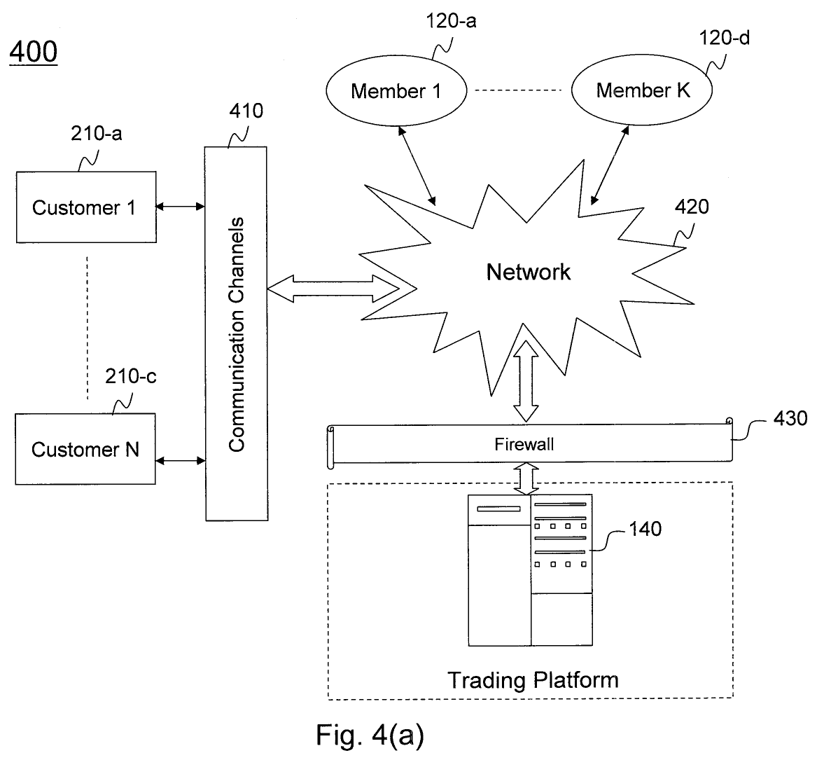

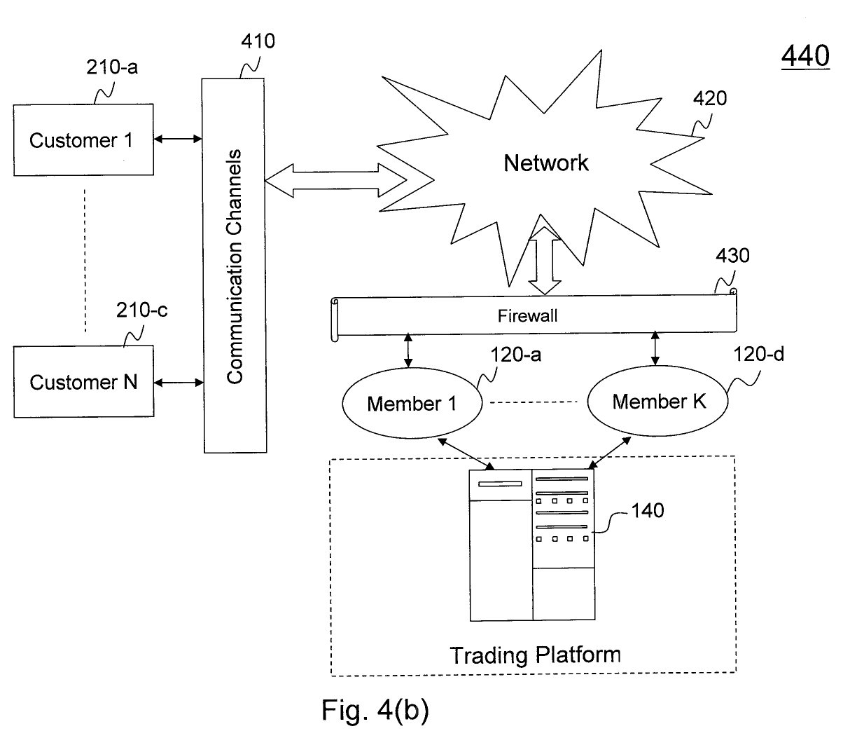

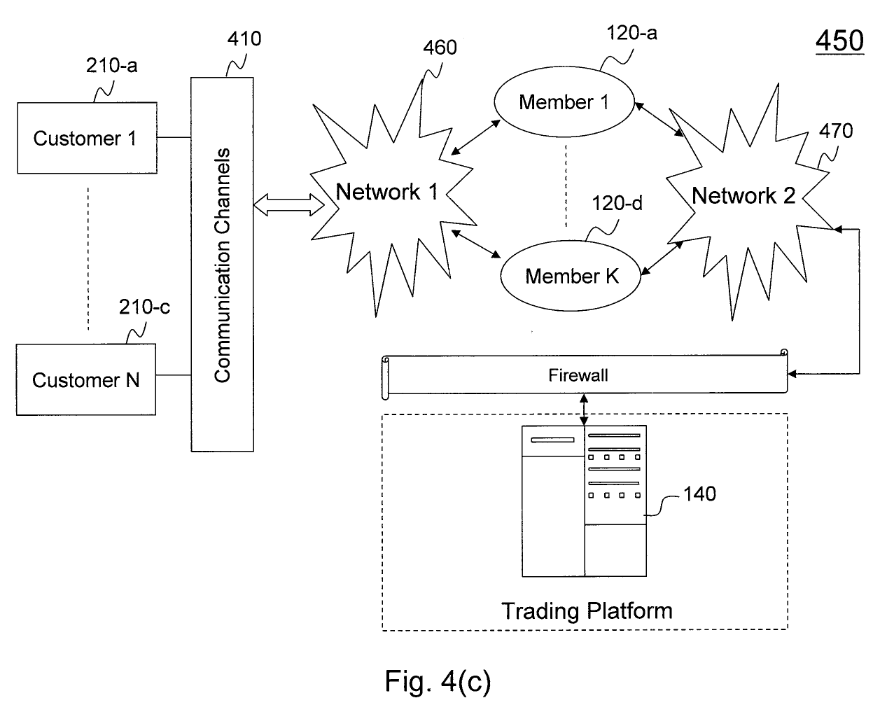

FIG. 4(a)-4(c) provide several exemplary system configurations of a network-based electronic trading system, according to embodiments of the present teaching. In FIG. 4(a), a configuration 400 is provided, in which customers 210-a, . . . , 210-b communicate with members 120-a, . . . , 120-d via network 420 through various communication channels 410. Members 120-a, . . . , 120-d communicate with the electronic trading platform 140 via the network 420. The trading platform 140 is behind a firewall 430 and members and customers are outside of the firewall. The communication channels 410 may enable a variety of way for the customers to communicate with members. For example, there may be special graphical user interfaces via the Internet through which customers may post their needs associated with their goods, e.g., sell needs or buy needs. The communication channel 410 may also include telephonic channels through which a customer may communicate with a member orally or in writing. Such telephony means may be supported by both wired or wireless domains. For example, telephonic means or short messages (SSM) may also be supported by the communication channels to allow a customer to send text messages to a member. In addition, an electronic email system may be provided to support a different means of communication. The firewall 430 in FIG. 4(a) is to protect the electronic trading platform 140 from security concerns and ensure integrity of data stored on and utilized by the electronic trading system.

The network 420 is generic. It includes, but is not limited to, a Public Switched Telephone Network (PSTN), the Internet, an Intranet, a proprietary network, a virtual network, a wireless network, a Local Area Network (LAN), a Wide Area Network (WAN), a dedicated network, or any combination thereof.

FIG. 4(b) illustrates a different alternative system configuration 440. In this embodiment, members of the platform operator 110 are placed behind the firewall 430 with all other parts of the system having the same configuration as in FIG. 4(a). In this configuration, members 120-a, . . . , 120-d can access more information without restriction from the electronic trading platform 140. This configuration may be more suitable when members and the platform operator 110 are more closely connected.

FIG. 4(c) illustrates yet another alternative system configuration 450. In this embodiment, members of the platform operator 110 are placed between two networks, network 1 460 and network 2 470. The network 1 460 is used for communication between customers and members. The network 2 470 is for the members to communicate with the electronic trading platform 140. For example, network 1 460 may be a wireless network to facilitate customers to communicate with members via, e.g., cellular phones or Personal Data Assistant devices or PDAs. Network 2 470 may be the Internet facilitating members to interface with the trading platform 140 via certain graphical user interfaces hosted on the web site of the platform operator 110.

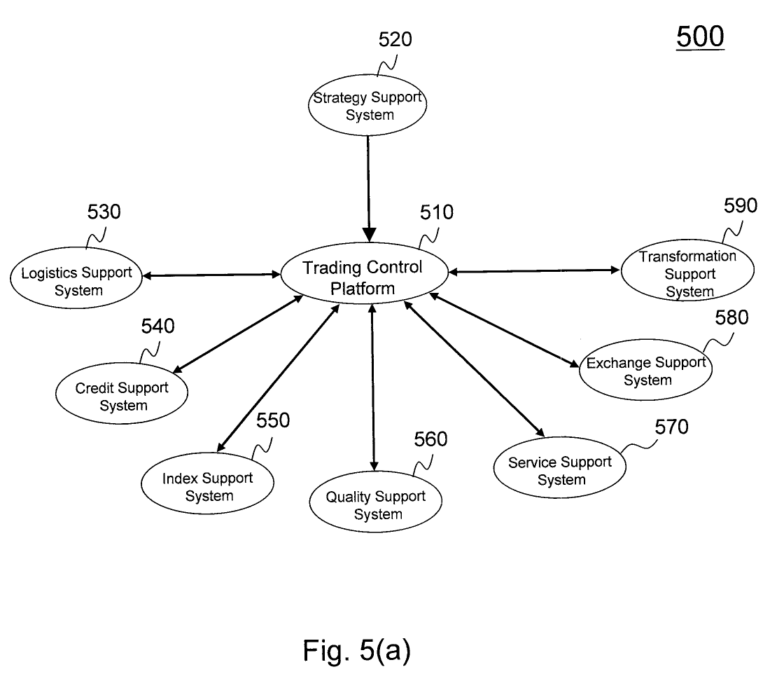

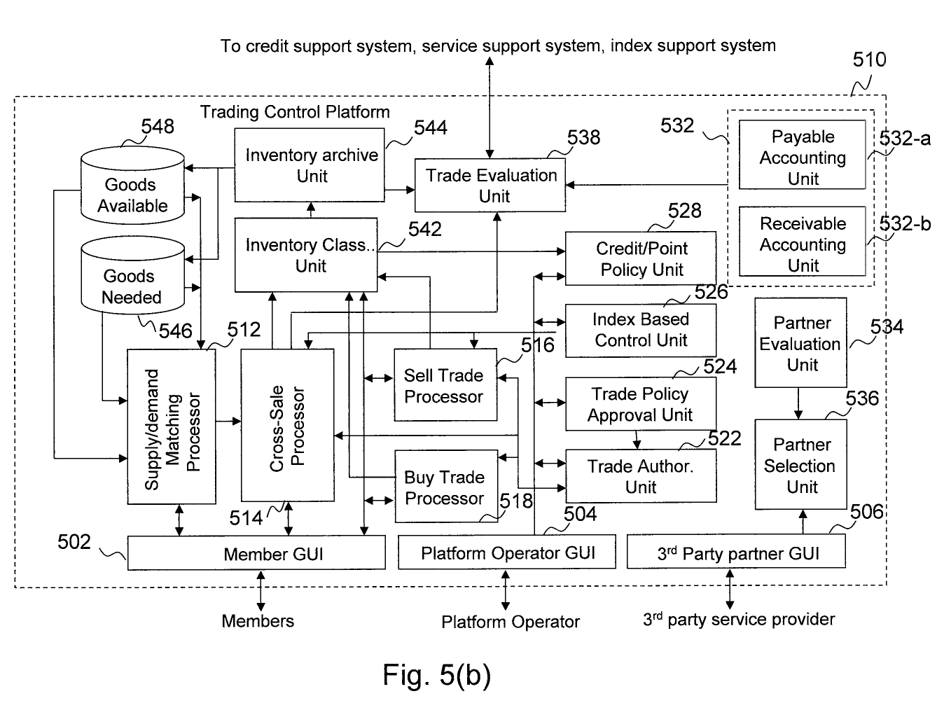

FIG. 5(a) depicts an exemplary high level construct 500 of the electronic trading platform 140, according to an embodiment of the present teaching. In this embodiment, the electronic trading platform 140 includes, but is not limited to, a plurality of sub-systems that support different functionalities required in order to enable the electronic trading platform 140 to perform the electronic trading activities as described herein. The high level construct 500 comprises a trading control platform 510, which connects to various other sub-systems, including, a strategy support system 520, a logistics support system 530, a credit support system 540, an Index support system 550, a quality support system 560, a service support system 570, an exchange support system 580, and a transformation support system 590. Each sub-system is described below in more detail with reference to their associated figures.

FIG. 5(b) shows an exemplary construct of the trading control platform 510, according to an embodiment of the present teaching. The trading control platform 510 may serve as a central sub-system of the electronic trading platform 140. As shown in FIG. 5(a), it connects to all other sub-systems and may serve to gather information from other sub-systems, to set up the operational parameters in other sub-systems, and to interface with members to accomplish various tasks that enable the trading platform 140. As illustrated in FIG. 5(b), the trading control system 510 includes various user interfaces used to control the communication between the electronic trading platform 140 and members of the platform operator 110, management of inventories that can be traded, means to facilitate trades among members, means to control trades based on an index price, or third party service provider management capabilities. Interfaces supported by the trading control platform include a member interface 502, a platform operator interface 504, and a third party partner interface 506.

The member interface 502 is to enable members to effectively communicate with the trading platform 140 regarding their activities and resolve issues related to various trades as well as terms associated with the relevant trades. For example, a member may be able to utilize the member interface to sign on a membership application or being notified on the status of their application to become a member. A member may also, upon being assigned to work with a customer, register a proposed trade between the customer and the platform operator 110. Through this interface, a member may also check his accumulated credit or points. A member may also use this interface to initiate or conduct a transfer of rights to trade goods to another member. In addition, through this interface, a member may also check all goods available or in need in order to identify a potential trade for his customers.

The platform operator interface 504 may be utilized by the platform operator 110 for various managerial related functions. For example, the platform operator 110 may specify certain criteria, via the platform operator interface, for authorizing a proposed trade. The platform operator 110 may also manually authorize a deal that is needed via the platform operator interface 504. The platform operator 110 may also set up certain policies via this interface. For example, policies regarding credit/point accumulation for members/customers may be set up and configured to control various stages of operations under the platform. The platform operator 110 may also check on or adjust an index price for certain types of goods traded via the same interface. Furthermore, the platform operator 110 may also control the execution of certain policies such as trade evaluation, etc.

The third party partner interface 506 may be designed for the trading platform 140 to interface with any third party service providers such as a delivery company (for delivering goods to different destinations) for signing up for providing services, information checking (schedule), service status update, or performance evaluation.

In addition to the interfaces 502, 504, and 506, the trading control platform may also include other sub-systems, e.g., a first single direction trade authorization mechanism (a sell trade processor 516, a buy trade processor 518, and a trade authorization unit 522), a mechanism to facilitate the second single direction trade (a supply-demand matching processor 512, a cross-sale processor 514, the trade authorization unit 522, and a trade evaluation unit 538), an inventory management mechanism (an inventory classification unit 542, an inventory archive unit 544, a goods available database 548, and a goods needed database 546), a policy enforcement mechanism (a trade approval policy unit 524, an index based control unit 526, and a credit/point policy unit 528), a third party service control mechanism (a partner evaluation unit 534 and a partner selection unit 536), and an accounting mechanism (payable accounting unit 532-a and receivable accounting unit 532-b).

The first single direction trade authorization mechanism may involve processing that supports the first trade (there are at least two single direction sales in order to complete a trade between a seller customer and a buyer customer). This mechanism may include a buy trade processor 518, a sell trade processor 516, a trade authorization unit 522, and an index based control unit 526. Members of the platform operator 110 may specify, propose, or structure different trades on the electronic trading platform 140 via interface 502. Such trades and information associated therewith may be classified according to the nature of the trade (e.g., buy or sell). Relevant information related to the classified trades may be processed by corresponding processors. For example, a buy trade and its associated information may be sent to the buy trade processor 518 so that information related to the trade can be analyzed. A sell trade and its associated information may be sent to the sell trade processor 516 so that information related to the trade can be analyzed.

Such analysis may include examination of the type of goods involved in the trade and market information about that type of goods. The analysis may also include obtaining an authorization for the underlying trade. Based on the analysis, the sell/buy trade processors may approve or reject proposed sales. The determination may be based on an approval related decision from the trade authorization unit 522, which may reach that decision based on analyzed information from the sell/buy trade processors 516 and 518 as well as certain policies for approving a trade from a trade approval policy unit 524.

Upon a trade being approved to proceed, the sell or buy trade processor may pass on information associated with the underlying trade to an inventory classification unit 542 for inventory maintenance purposes. The inventory classification unit 542 may then classify the current trade into a certain category (e.g., a certain grade of steel) and send the classification to the inventory archiving unit 544 so that the trade and its related information may be archived in databases “Goods available” and “goods needed”. Such separate databases may facilitate the system to match a need against all supplies or vice versa.

With all trades in the inventory sorted or categorized, the supply-demand matching processor 512 may present such information to members through the member interface 502 to facilitate members to identify the second single direction trade. In some embodiments, a member may identify, based on his need, appropriate inventory as a potential to complete the second single direction sale. For instance, if a member has the right to sell 5,000 tons of steel at a certain unit price (for the platform operator 110), the member likely will examine all the inventory listing for the same type of steel extracted from database “goods needed” (under other members who want to buy) to look for a potential buyer in order to put together a second single direction sale. This is a matching process. In some embodiments, the matching can be done automatically and such identified matches may be presented to the member as suggested matches so that the member can select appropriate ones that fit his needs to proceed.

Such identified matches usually have corresponding listings related to other members. For example, if a member who intends to sell 5,000 tons of steel for a seller customer at a price may find a match that corresponds to a member who wants to purchase 5,000 tons of the same type of steel for a buyer customer with an acceptable price (which may not be the same as the price of the selling member). In this case, the sale is to proceed between the two members. In some situations, the quantity that needs to be sold by the seller member may not be the same as the quantity needed by the buyer member. For example, the quantity that needs to be sold is larger than the quantity wanted by a matched buyer member. In that case, the seller may split the quantity needs to be sold into smaller quantities and proceed with the sale with a smaller quantity that is currently needed. The seller member may keep the remainder quantity on the listing of “goods available” which will allow further matching for subsequent sales. This is a so called split sale. Similarly, if the quantity available is smaller than the quantity needed, the buyer member may split the needed quantity into two needs and use the currently available quantity to meet one need first and keep the remainder quantity on the listing of “goods needed” to facilitate future matches.

Once the match is found, information related to the sale is sent to the cross-sale processor 514, where the trade from the match may also need to be authorized by the trade authorization unit 522. Upon an approval of the trade from the match, the cross-sale processor may inform the inventory classification unit to update the inventory, which will further trigger the inventory archiving unit to update the databases 548 and 546. In addition, the trade evaluation unit 538 may gather relevant information associated with this trade for evaluation purposes, e.g., the price used and the quantity traded. Such evaluation may later be used to, e.g., collect information useful for establishing an understanding of the market. The changes made in the inventory based on the approved trade may also be sent to the credit/point policy unit as a reference for future credit/point policy evaluation purposes.

When a trade is made for goods, the electronic trading system supports logistics arrangement and delivery. A third party service provider such as a delivery company may use the 3rd party partner interface 506 to receive a scheduled delivery, to update execution status, reporting problems, or for notification of conclusion of a service. Such information may be used by the partner selection unit 536, in connection with the information from the partner evaluation unit 534 so that the platform operator 110 may use such information to update the list of partners for providing services to the customers of the trading platform 140. This can be done through the platform operator interface 504 to communicate with the partner selection unit 536.

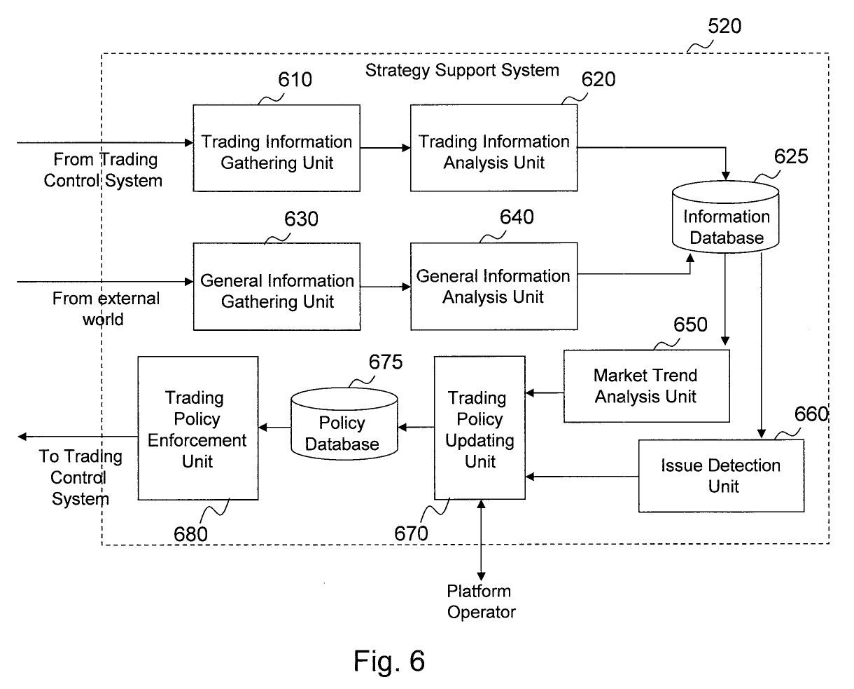

FIG. 6 shows an exemplary detailed construct of the strategy support system 520, according to an embodiment of the present teaching. This is a sub-system where high level strategic decisions/policies regarding the operations of the electronic trading platform 140 are made. As an illustration, information from various sources such as the market and the past trades may be collected as a basis for the policy decisions. Appropriate analysis may be performed on the collected information so that adaptive decisions that are strategic to the platform operator 110 may be made on a timely basis. The illustrated strategy support system 520 comprises a trading information gathering unit 610, a trading information analysis unit 620, a general market information gathering unit 630, a general market information analysis unit 640, a market trend analysis unit 650, an issue detection unit 660, and a trading policy updating unit 670. Once the trading policies are made, a trading policy enforcement unit 680 may be activated to enforce the policies. This unit may interact with another trade authorization unit (e.g., 522) to make decisions as to whether a trade is to be approved based on the consideration of the trading policies.

The trading information gathering unit 610 may continuously collect information related to all transactions performed via the trading platform 140. Such information may be analyzed, sorted, categorized, and then stored in an information database 625. In addition to the trading information, the information gathering unit 630 may collect a wide range of relevant information associated with the goods traded on the trading platform 140. This may be to ensure that the trading performed on the trading platform 140 described herein is consistent with the market. Such general market information is analyzed at the general information analysis unit 640 and the analysis result is stored in the information database 625.

The market trend analysis unit 650 retrieves information related to the market from the database 625 to determine the market trend based on, e.g., any available or novel economic theory. Similarly, the trading information stored in the information database 625 may also be retrieved for detecting any potential problems. This is performed by the issue detection unit 660. For instance, an issue of dumping may be detected if the trading information reveals that there have been trades in the system that consistently sold goods at a price lower than the current market. Such detected issues, together with the market trend analysis result, may then be sent to the trading policy updating unit 670, where more detailed analysis can be conducted to see whether an update to the current trading policies of the electronic trading platform 140 is warranted. Such a decision can be made automatically or manually by the platform operator 110 or jointly.

When the trading policies are changed, the trading policy updating unit 670 updates the policy database 675 so that the updated policies can be used by the trading policy enforcement unit 680 to control the trading activities.

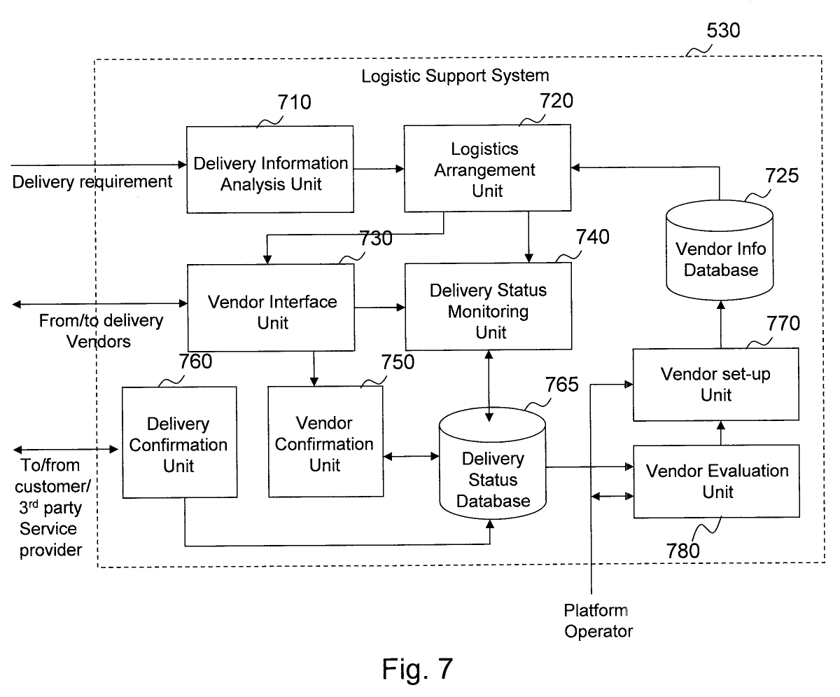

FIG. 7 shows an exemplary construct of the logistic support system 530, according to an embodiment of the present teaching. The electronic trading platform 140 is for tangible goods. To complete a transaction, delivery of the sold goods is an important step. The logistic support system 530 is designed for that purpose. The logistic support system 530 comprises a delivery information analysis unit 710, a logistics arrangement unit 720, a delivery status monitoring unit 740, a vendor interface unit 730, a vendor confirmation unit 750, and a delivery confirmation unit 760. Optionally, the logistics support system 530 may also include a vendor database 725 recording information related to all vendors who sign up with the electronic trading platform 140 to provide services related to goods delivery. Such a database is populated via a vendor set-up unit 770 that may take sign-up information from the platform operator 110 or from a vendor (not shown). The vendors enlisted in the electronic trading platform 140 may be updated dynamically based on performance. There can be a vendor evaluation unit 780 which can utilize service performance information retrieved from a delivery status database 765 to reach an assessment of the service quality. Based on the performance evaluation, the platform operator 110 may adaptively update the enlisted vendor information by, e.g., removing unqualified vendors and supplying new vendors.

To make logistics arrangements for each trade, the delivery information analysis unit 710 receives information describing the specific delivery requirement and sends such information to the logistics arrangement unit 720. Based on the delivery requirement, e.g., location of delivery and time requirement, the logistics arrangement unit 720 yields specific delivery arrangements. This may include for each route, which vendor is to be used and when. Such arrangement information is then sent to the delivery status monitoring unit 740 to initiate the monitoring schedule. This information is also sent to the vendor interface unit 730, which may initiate communication to the vendor, e.g., informing it the scheduled service, or receive responses from the vendor, e.g., acknowledging the receipt of the instruction and indication of taking action to fulfill the order.

During the execution period of arranged logistics, the vendor interface 730 may keep in touch of the vendor(s) involved in a particular delivery of goods. When information is received from a vendor, the vendor interface 730 sends such information to the delivery status monitoring unit 740, which subsequently updates the status information stored in the delivery status database 765. If the vendor interface unit 730 receives a confirmation from a vendor confirming the delivery, the vendor interface unit 730 invokes the vendor confirmation unit 750, which may also update the delivery status database to indicate a completion of the delivery. However, since a buyer (either the platform operator 110 or a buyer customer) is the party who receives the delivery, the delivery confirmation unit 760 also monitors the communication with the buyer. When the delivery confirmation unit 760 receives an indication of a successful delivery, the delivery confirmation unit 760 updates the delivery status database 765, which may then concludes the delivery. If the delivery confirmation unit 760 receives a confirmation indicating a failure in delivery, the delivery confirmation unit 760 records the information in the delivery status database 765, which may be accessed by the vendor evaluation unit 780 for assessment. It is also possible that a confirmed failure of goods delivery may trigger a third party independent evaluation of the performance. Such a third party service provider may also communicate with the delivery confirmation unit 760 to provider its assessment, which will also be stored in the delivery status database 765 and will be used for performance evaluation purposes.

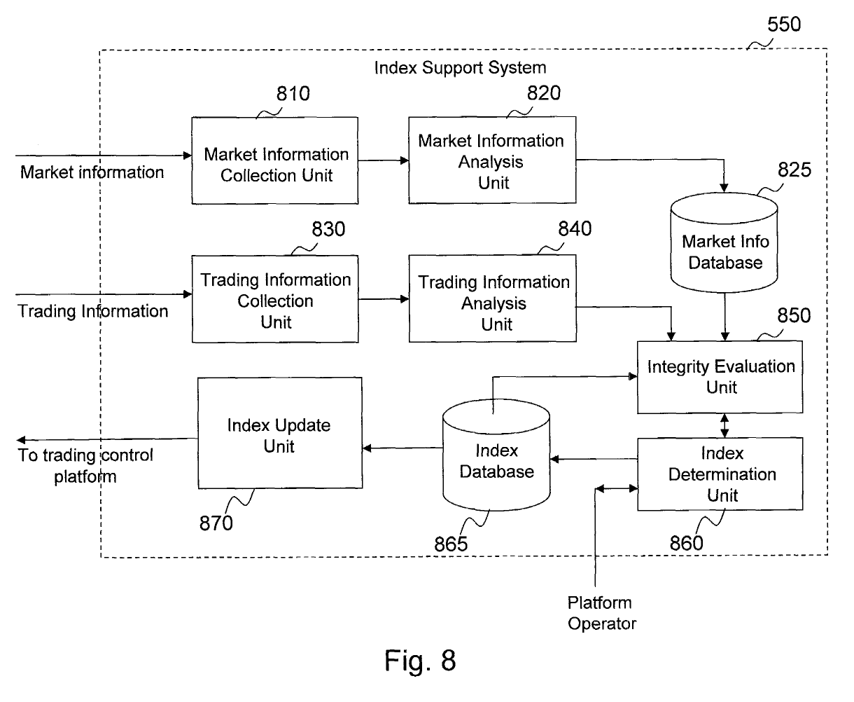

FIG. 8 shows an exemplary construct of the index support system 550, according to an embodiment of the present teaching. An index herein refers to a reference, which others use in deciding a trading price. To exercise control over trading activities, the platform operator 110 (see FIG. 1) establishes an index price for different goods. An index price for a certain goods is to be used as a gauge to ensure that prices used in different trading activities are, e.g., consistent with the market price. Thus, the index price is to be adaptively adjusted over time. The adjustment may be made to ensure that the trading price used for different goods traded using the electronic trading platform 140 (see FIG. 1) is within reasonable bounds of the market price.

The exemplary index support system 550 comprises a market information collection unit 810, a market information analysis unit 820, a trading information collection unit 830, a trading information analysis unit 840, an integrity evaluation unit 850, an index determination unit 860, and an index update unit 870. When market information is collected, via the market information collection unit 810, such information is analyzed by the market information analysis unit 820 and stored in a market information database 825. Such analyzed market information can then be retrieved dynamically from the database 825.

To adaptively adjust an index, the integrity evaluation unit 850 assesses the reasonableness of the index based on the analyzed market information together with information associated with past trading information, gathered by the trading information collection unit 830 and analyzed by the trading information analysis unit 840, to determine whether the current index is consistent with the market or the near future of the market. Such a decision is sent to the index determination unit 860. If the decision is yes, there may be no adjustment made to the index. If the decision is no, the index determination unit 860 may then interact with the platform operator 110 to set up a new index. The index determination unit 860 may also produce an automatically generated updated index based on the information provided by the integrity evaluation unit 850. Such an automatically generated adjustment to the index may then be presented to the platform operator 110 to obtain a confirmation. The confirmed new index value can then be used to update the index stored in the index database. With an adaptive index, the index update unit 870 may then retrieve the updated index value and then send it to the index based control unit 526 of the trading control platform 510 so that the updated index can be used to control the trading activities.

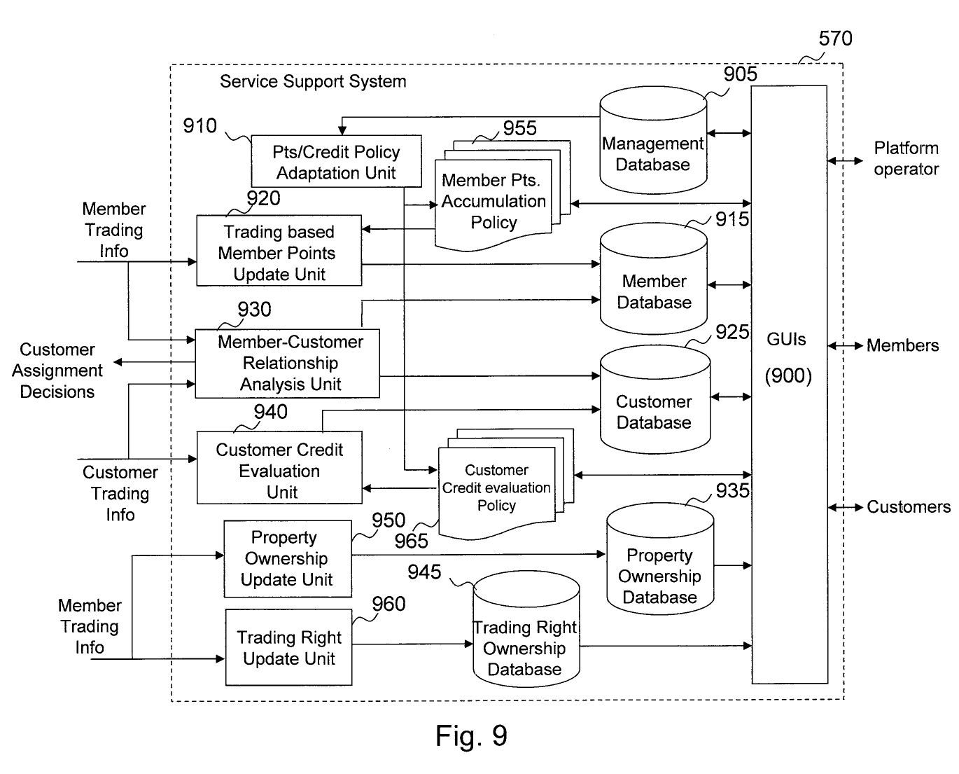

FIG. 9 shows an exemplary construct of the service support system 570, according to an embodiment of the present teaching. The service support system 570 is a basic system in the electronic trading platform 140 (see FIG. 1) and provides functional modules/units commonly needed by different sub-systems. The exemplary service support system 570 comprises a user interface 900 that enables the platform operator 110 (see FIG. 1), members, and optional customers to interact with the electronic trading platform 140. For example, the platform operator 110 may set up certain managerial rules via the user interface 900 and such rules may be stored in a management database 905 and are used to control various functions of the trading platform 140. In addition, the platform operator 110 may also set up rules used in determining accumulated points for members and such rules may be stored as member points accumulation policy 955. Similarly, the platform operator 110 may also set up rules regarding how a customer may be evaluated, e.g., based on credit. In this case, such specified rules regarding customer evaluation may be stored as customer credit evaluation policy 965.

Those set rules, including management rules, points accumulation policies, or customer evaluation policies, may be, once stored, retrieved from the respective storage space to enforce in the management of trades conducted on the trading platform 140. In some embodiments, some of the policies, as applied to, e.g., members or customers, may be adapted over time. This is illustrated in FIG. 9, where a points/credit policy adaptation unit 910 may be provided to adapt member/customer evaluation policies based on current management rules stored in the management database 905. Such adaptation may yield dynamically changed policies for members or customers, which can be used to update the member points accumulation policy 955 and customer credit evaluation policy 965.

The user interface 900 may also provide means for members or optionally customers to interact with the electronic trading platform 140. For example, new members may sign up with the platform operator 110 and provide personalized information to the platform operator 110 via the user interface 900. Such information may be archived in a member database 915. When needed, the member information can be retrieved, used, or displayed. For each member, the platform operator 110 may also incorporate additional information that the platform operator 110 considers to be relevant. For example, the platform operator 110 may allow each member to have an accumulated point, which may reflect the achievement of the member. Such accumulated point may be stored together with the individual information associated with the member and can be updated dynamically. A trading based member point update unit 920 may access information related to trading conducted by different members and then accordingly update the accumulated points associated with such members. The update may be performed based on the member point accumulation policy 955 and the member database 915 is updated in accordance with the dynamically changed accumulated points.

In addition to points, each member may have an associated credit, which can be used to evaluate the member. Such credit for each member may also be stored together with the information related to the member in the member database 915. In some embodiments, such a credit for each member can be computed in an accumulative manner.

Similar to member information, information related to individual customers may be gathered via the user interface 900, e.g., from the platform operator 110, members, or customers themselves, and then stored in a customer database 925. Such customer information can be retrieved from the customer database 925 and used for various purposes. Each customer may be evaluated and the evaluation result may be also stored in the customer database 925. For instance, for each customer, a credit may be derived based on the past trading that occurred between members of the platform operator 110 and the customer. Such a credit may be accumulative and can be updated dynamically. For example, whenever a member conducts a trade with a customer, e.g., sells goods to the customer, when the deal concludes, the credit associated with the customer may be updated based on, e.g., the timeliness of payment or how easy it was to deal with the customer.

As mentioned above, customers associated with a particular member may be changed dynamically. Such a change may be made based on various observations such as whether the member is suitable for handling the customer relationship or whether a particular customer gets along with the member. Those observations may be made based on the dealings in trades. Therefore, optionally, the service support system 570 may also include a member-customer relationship analysis unit 930 that receives information related to member trading and customer trading and perform analysis based on some pre-determine criteria. Upon such an analysis, the member-customer relationship analysis unit 930 may generate customer assignment decisions, which can be used to modify which members should be responsible for which customers. In some situations, a decision may be made that certain members may not be suitable to handle customer relationships. In that case, no customers may be assigned to such members. However, such members may still be able to trade with other members on the right to trade. Any decision made as such will be used to update the member and customer database 915 and 925 to reflect the relationship between customers and members.

As discussed herein, the property right of goods being traded and the right to trade such goods are separate and assigned to different parties. Specifically, the property rights of goods belong to the platform operator 110 and the right to trade such goods is assigned to members. Such distributions of rights are archived and the assignments of different rights associated with all goods being traded under the trading platform 140 are recorded in two databases, a property ownership database 935 and a trading right ownership database 945. The distribution of rights may change over time. For example, the property ownership of certain goods may change when the goods are sold. In addition, when one member trades his right to trade a certain quantity of goods to another member (for a gain), the trading right ownership database 945 needs to be updated accordingly to reflect that change. This is done by a property ownership update unit 950 and a trading right update unit 960 based on information associated with trading, either on goods or on right to trade, performed by members.

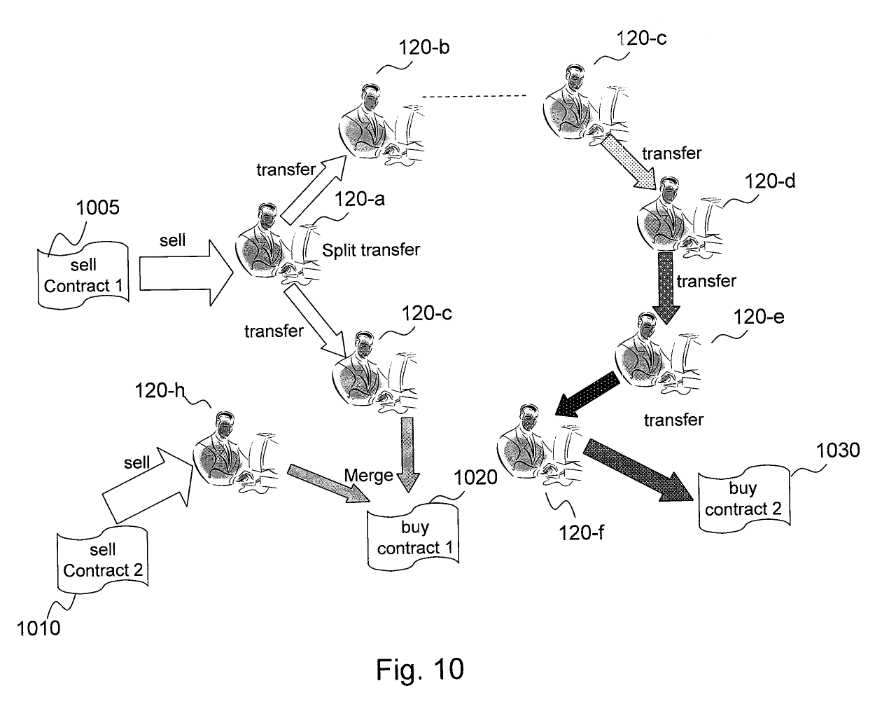

FIG. 10 illustrates exemplary trading relationships among members of the platform operator 110, according to an embodiment of the present teaching in FIG. 10, there are a plurality of members 120-a, . . . , 120-h. Member 120-a enters into a sell contract 1005 with a seller customer (not shown) and member 120-h enters into another sell contract 1010 with a different seller customer (not shown). Each of the members receives the right to trade the goods sold to the platform operator 110 under the respective sell contract. They may trade such right with other members or exercise such right to sell the goods to a customer. In this illustration, member 120-a splits the goods from the sell contract 1005 into two portions and then transfers the right to trade the first portion to member 120-b and that of the second portion to member 120-g. Such transfers of right to trade may provide member 120-a gains on each.

As discussed herein, the re-distribution of the rights to trade among members create gains for the members. For example, assuming that a first member has the right to trade some goods (for which the member has the right to trade) at a selling price of $100 per ton. If a second member, although not having the right to trade the goods, offers to buy the goods at a price higher than $100 per ton, say $120 per ton. In this case, the first member can trade with the second member on his right to trade the goods for a gain, determined, e.g., based on the difference in price between $100 and $120 and the total volume of the goods implicated.

Referring back to FIG. 10, upon receiving the right to trade the first portion of the goods from the sell contract 1005, member 120-b may subsequently further transfer the right to one or more other members for a gain and such trade may continue among members. In this illustration, the right is transferred to members 120-c, 120-d, 120-e, and 120-f, who then sells the first portion of the goods to a buyer customer under a buy contract 1030.

On the other hand, member 120-g who receives the right to trade on the second portion of the goods sells this portion of the goods, together with the goods from the sell contract 1010 (merged) to a buyer customer under a contract 1020. During these transactions, when members transfer their rights to trade, the originating member receives a gain from the receiving member. Such gain may or may not contribute to the points associated with the respective members, depending on the specific policies regarding points accumulation. Among members, one member may also assign credit to another (not shown).

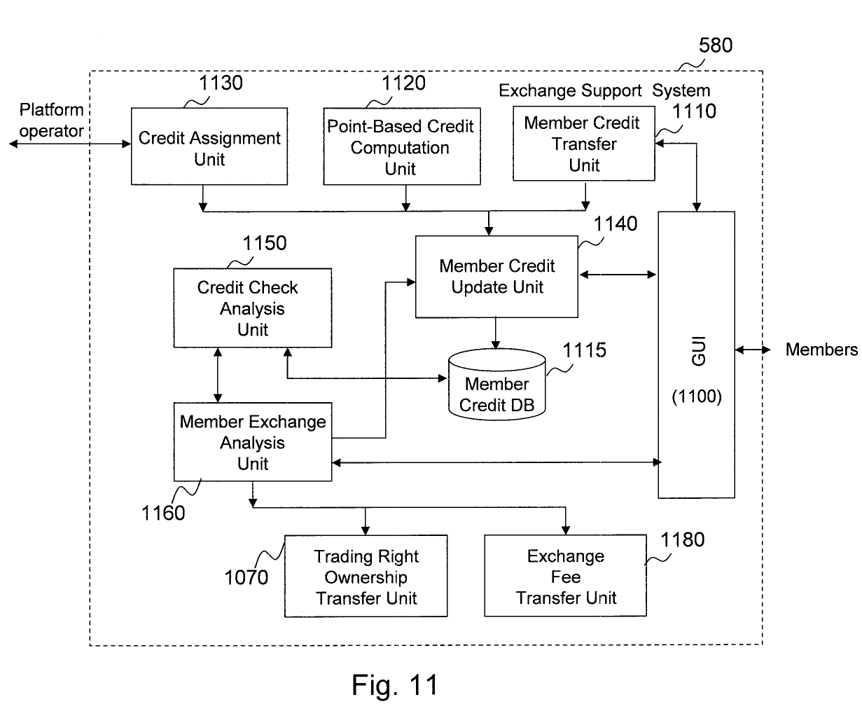

FIG. 11 shows an exemplary construct of the exchange support system 580, according to an embodiment of the present teaching. “Exchange” refers to the scenario in which members transfer their rights to trade. In this exemplary construct, there is a user interface 1100, which allows a member to interact with the electronic trading platform 140 for the purpose of exchanging trading rights with another member. When a member enters information related to an exchange via the interface 1100, the information associated with such an exchange is sent to a member exchange analysis unit 1160. The proposed exchange is analyzed based on, e.g., member credit received from a member credit check analysis unit 1150. Credit for each member may be stored in a member credit database 1115 and can be retrieved, e.g., by the member credit analysis unit 1150 for the purpose of approving a proposed exchange.

The credit of each member may come from a plurality of sources. For example, each member may be given an initial level of credit when the member signs up with the platform operator 110. This initial credit may be provided by the platform operator 110 via a credit assignment unit 1130. Such initial assigned credit may be updated over time. For example, the platform operator 110 may subsequently update the credit of its members. In addition, one member may give another member some credit via a member credit transfer unit 1110. Furthermore, when a member conducts certain trade, which causes an update in terms of accumulated points associated with the member. Such point update may also affect the credit of the member, depending on specific platform operational policies. Whenever there is a credit change from any of the above discussed sources, a member credit update unit 1140 is invoked to update the member credit database 1115.

The accumulated points or the credit for a member affects the member's trade activities. For example, the higher the accumulated points for a member, the higher the credit associated with the same member. Such credit and points of a member may later be used to evaluate a proposed trade by this member. The higher the points or credit, the better chance the member gets to obtain approval for a proposed trade. Optionally, it may be that the higher the credit/points, the bigger trade that the member may propose and receive an approval.

When a proposed exchange is approved, the member exchange analysis unit 1160 invokes a trading right ownership transfer unit 1170 that performs operations to update the record for distribution of rights to trade among members. In addition, the member exchange analysis unit 1160 may also invoke an exchange fee transfer unit 1180 that is responsible for arranging a payment from a receiving member to an initiating member in accordance with the term of the exchange.

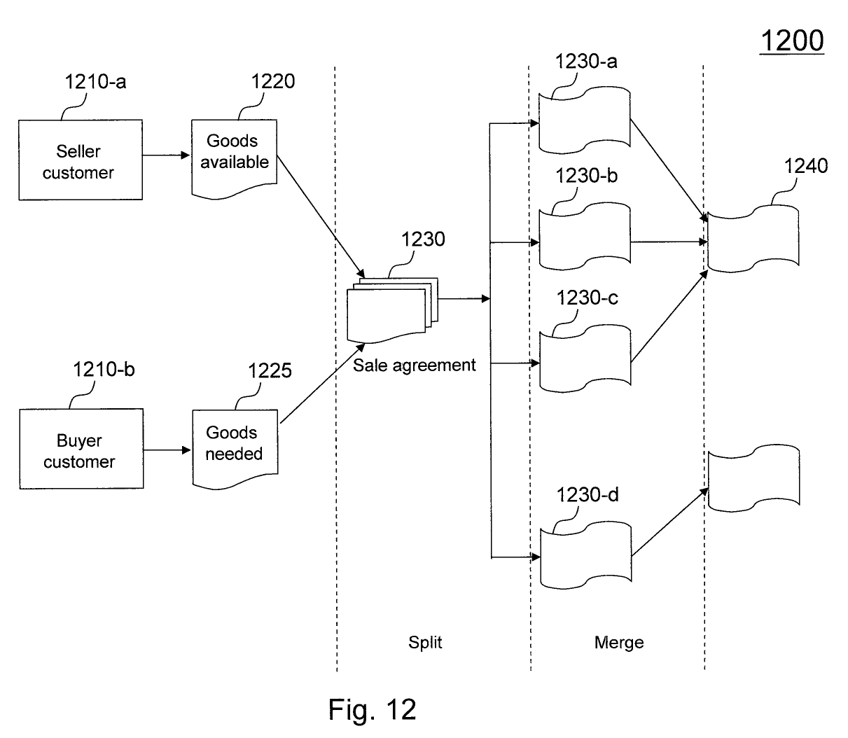

By transferring right to trade among members, the underlying goods associated with the transferred right to trade is also transferred from a transferring member to a receiving member. This is an internal trade of rights to trade but not in the conventional sense of trade of goods although the goods may be enlisted under a different member. Such internal trades may not be based on needs but driven by profit gaining for members. For example, a first member may facilitate a deal between the platform operator 110 and a seller customer to purchase 1,000 tons of goods and has the right to trade the purchased goods. FIG. 10 illustrates the possible forms of transferring the right to trade that a member can carry out, including the right to trade the entire volume of the goods or that of a partial volume. FIG. 12 illustrates the possible forms of transferring of a right to trade that a member can carry out, including a trade on the full volume, a trade on a partial volume in a split trade, or even a trade that includes goods from another member in a merged trade.

In FIG. 12, deals with seller customers (1210-a) and buyer customers (1210-b) lead to two separate inventories, namely goods available (1220) and goods needed (1225), all of which are associated with sale agreements 1230 (for buys or sells). The goods available may be in the form of forward goods (not yet actually available) or actual goods (already available). The inventory under each sale agreement can be further traded by a member who has the right to trade the inventory. The subsequent trade(s) can be in the form of a whole sale deal (full volume sale), a split sale deal (partial volume sale), or a merged sale (combined with goods from a different sale agreement). Such transactions can be between members (transfer of right to trade) or between a member and a customer (actual transaction on goods). In addition, those transactions can be trade on agreement (i.e., transfer of right to trade) or on actual goods.

In the example illustrated in FIG. 12, a sale agreement 1230 can be split into four deals, 1230-a, 1230-b, 1230-c, and 1230-d. Split sales may occur either for goods not yet made (a forward sale agreement) or goods already available. A forward sale agreement may stipulate, e.g., that a certain goods will be produced in a certain quantity each month of 5 years starting from 5 months from the date of the agreement. When this sale agreement is entered into between a seller customer and the platform operator 110 via a member, no actual goods may be available for delivery. However, this sale agreement can be traded once the parties enter into the agreement.

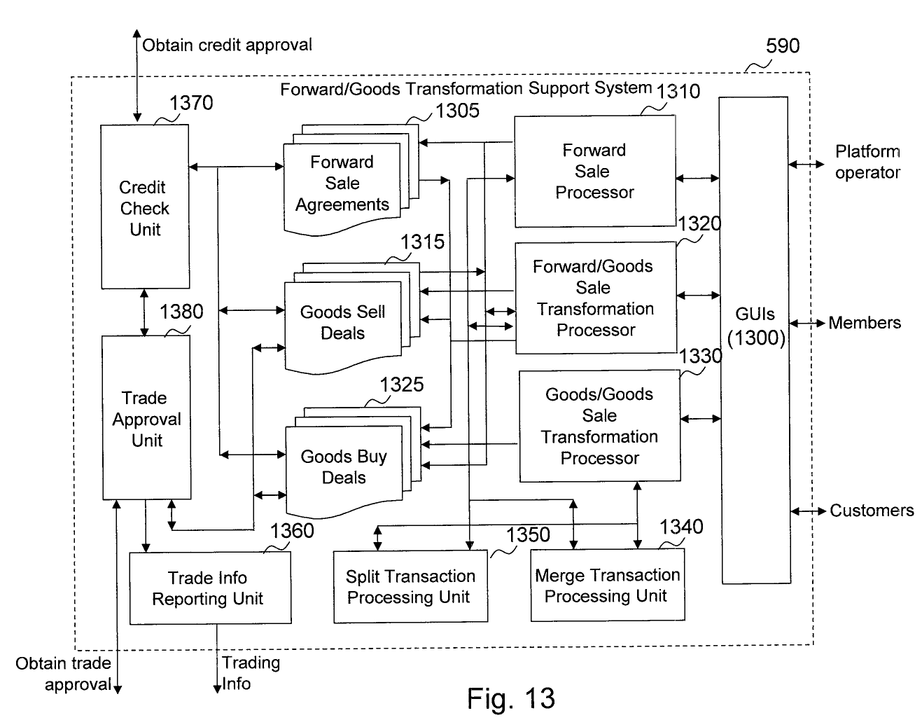

The right to trade this forward sale agreement belongs to the member and can be transferred in any one of the aforementioned mode (whole, split, or merge). For instance, the entire forward agreement can be transferred to a different member. The right to trade the goods to be produced in the first two years may be transferred to one member and the right to trade the goods to be produced in the remaining three years may be transferred to another different member in a split trade. In addition, up to some point, a member who holds the right to trade at least a portion of the goods stated in a forward sale agreement will have actual goods to trade. At that point, the nature of further trade is no longer on a forward sale agreement but rather on actual goods. The electronic trading platform 140 is designed to support that transition from a forward sale agreement trading to actual goods trading. Details are discussed with reference to FIG. 13.

Individual inventories may also be merged in a merged transaction. For example, inventory 1230-a, 1230-b, and 1230-c may be merged in a one transaction 1240. In this example, 1230-a, 1230-b, and 1230-c may not be necessarily the outcome of a split but rather three separate inventories. Through such internal transactions among members, although the property rights for the goods remain the same (to the platform operator 110), the rights to further trade held by members are re-distributed.

FIG. 13 shows an exemplary construct of the transformation support system 590, according to an embodiment of the present teaching. This sub-system facilitates various possible trade transformations performed via the electronic trading platform 140. Such transformations include one-to-many transformation with regard to either forward or actual goods sale agreement and many-to-one transformation with regard to either forward or actual goods sale agreement. A one-to-many transformation corresponds to a split trade situation. A many-to-one transformation corresponds to a merge trade situation.

In the transformation support system 590, there is a user interface 1300, through which the platform operator 110, members, and optionally customers may interact with the electronic trading platform 140. The user interface 1300 may have separated interfaces for the platform operator 110, members, or customers. Through this interface, members may visualize inventories in goods-available and goods-needed so that opportunities for trading their own inventories can be identified. To facilitate that, the interface 1300 may be connected with the trading control platform (FIG. 5(b)) and retrieve inventory information from databases 548 and 546 and present the retrieved information to the members.

Through the user interface 1300, members may perform any one of the transformations mentioned above. For a transformation from a forward sale agreement to a forward sale agreement (split or merge), a forward sale processor 1310 may be invoked to process the trade. If a trade involves a transformation from a forward sale agreement to an agreement involving actual goods (split or merge), or vice versa, a forward/goods sale transformation processor 1320 is activated to process the trade. In addition, if a sale transformation involving only goods (either split or merge), a goods/goods sale transformation processor 1330 is invoked to perform the necessary processings. Depending on whether a trade is a split trade, each of the processors 1310, 1320, and 1330 may activate a split transaction processing unit 1350 to process a transaction involving split of a previously existing agreement. Similarly, if current trade involves a merge trade, each of the processors 1310, 1320, and 1330 may activate a merge transaction processing unit 1340 to process a transaction involving merge of two or more previously existing agreements.

Each trade via a transformation likely will yield new agreement(s), which can be a forward sale agreement (1305), a sell agreement (1315), or a buy agreement (1330). Different types of agreement may be stored in separate storages. Trades represented by these agreements may need to be approved by a trade approval unit 1380. For example, the trade approval unit 1380 may perform a credit check, via a credit check unit 1370, on members involved in the current trade. Acting on a request to perform a credit check, the credit check unit 1370 may retrieve credit information maintained, e.g., in the exchange support system 580 (see FIG. 11) and determine whether the existing credit is adequate for the current trade. If the credit is adequate, a confirmation may be sent to the trade approval unit 1380.

In some embodiments, different types of trades may require different types of approval. For instance, it is also possible that only certain types of transactions that require approval beyond credit check. For instance, a forward sale may not require additional approval beyond credit check. However, for other types of trades involving goods, the trade approval unit 1380 may also obtain approval determined based on other types of information. For instance, if the market analysis shows that the market price for the type of goods involved in the current trade has fallen below the purchase price used in the current trade, the trade approval unit 1380 may not approve the trade in order to protect the interest of the platform operator 110. In addition, it is also possible that, for a trade with a volume exceeding a certain pre-determine threshold, the trade approval unit 1380 may obtain an approval from the platform operator 110.

When a trade is approved, the trade approval unit 1380 may set a flag for the sale agreement stored in storage 1305, 1315, or 1325. Similarly, the credit check unit 1370 may also perform the same to indicate that an agreement has been approved based on credit check. In this way, the agreements stored in storage 1305, 1315, and 1325 can be validated as effective agreement. In addition, upon approving a trade, the trade approval unit 1380 may send information related to the approved trade to a trade information reporting unit 1360. The trade information reporting unit 1360 may report relevant information to the strategy support system 520 (see FIG. 6) where continuous trading data can be gathered and analyzed to dynamically determine the trading policies used by the electronic trading platform 140. In addition, the trading information reporting unit 1360 may also send relevant trading information associated with the approved trade to the index support system 550 (see FIG. 8) so that an adaptive index used to guide all trading activities may be dynamically updated based on the trading information provided on an on-going basis.

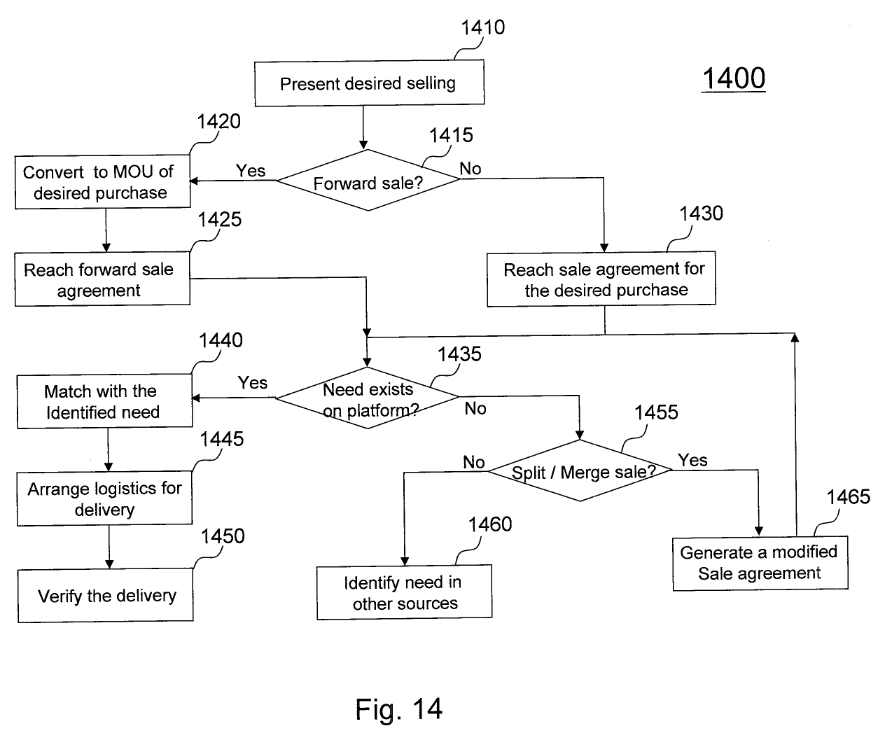

FIG. 14 is a flowchart of an exemplary process for a transaction between a seller customer and the platform operator 110 and subsequent trades via the electronic trading platform 140, according to an embodiment of the present teaching. A seller customer may first present a desire, at 1410, to sell a certain quantity of a certain type of goods at a certain price. It is determined, at 1415, whether the desired sell is a forward sale. If it is a forward sale, a Memorandum Of Understanding (MOU) regarding the sale may first be issued, at 1420, before a forward sale agreement is reached between the seller customer and the platform operator 110 via a member at 1425. If the desired sell involves actual goods, a sale agreement between the seller customer and the platform operator 110 via a member is reached, at 1430.

As discussed herein, a sale agreement, whether forward or non-forward, can be further traded among members. During such trading activities, the original sale agreement may be split or merged or sold. Such further trading activities are based on a demand and supply match. To further trade, it is first determined, at 1435, whether there is a fit of a need in the inventory for the goods covered in the sale agreement if there is no fit, it is further determined, at 1455, whether the volume of goods covered in the original sale agreement may be split or merged to find a fit in the inventory. If it is not possible to find a fit even when split or merge is applied, a fit may be identified through other sources at 1460. If it is possible to find a fit through a split or a merge, a modified sale agreement is generated at 1465. For example, if a split is applied, multiple sale agreements may be generated based on the original agreement and each represents a split sale agreement. The newly generated sale agreements are then used, at 1435, to identify possible need.

If a need is identified, a match is performed between a sale agreement and the identified need at 1440. The match may include various aspects of the trade. For instance, there is a match of the quantity, price, and delivery site. A match may be in the sense of either an exact match or an inexact match. For instance, if the asking price is higher than a offered price, there can still be a match as long as there is an agreement on a final price. The match may also include destinations. For example, if goods to be traded is currently at a physical location and a buyer customer requires the goods to be delivered to a different destination, the match process includes to fill in the delivery location of the sold goods as the destination required by the buyer customer and, hence, a match.

Once a match is found, to deliver the goods, logistics arrangement is made at 1445. The delivery of the goods traded can then be executed and verified at 1450. The verification may be performed by the buyer customer or a third party service provider.

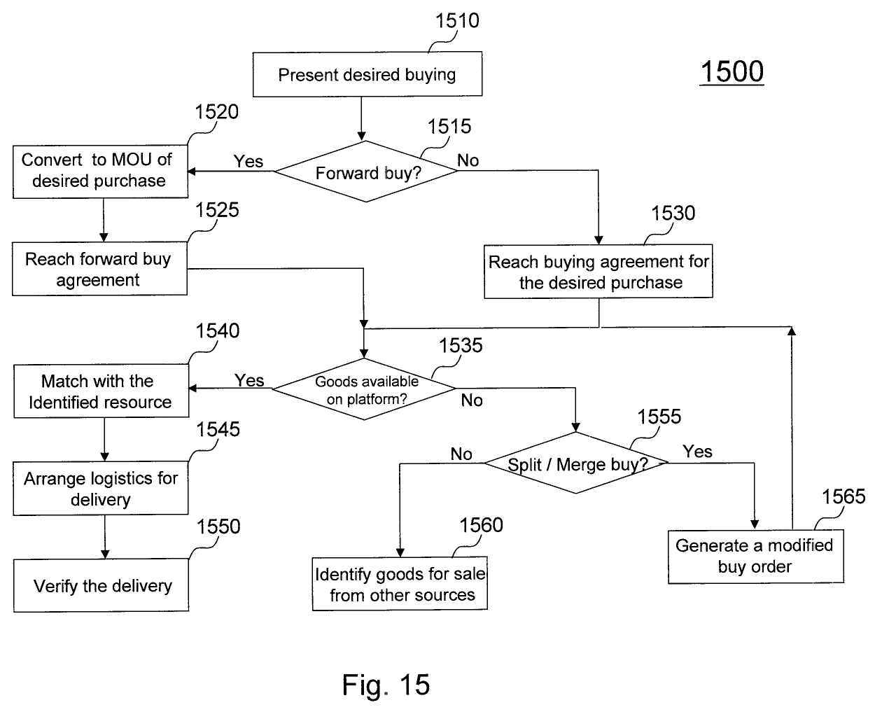

FIG. 15 is a flowchart of an exemplary process for a transaction between a buyer customer and the platform operator 110, according to an embodiment of the present teaching. This is a buying process compared with the selling process depicted in FIG. 14 but the flow is similar to the selling process but with reverse trade function.

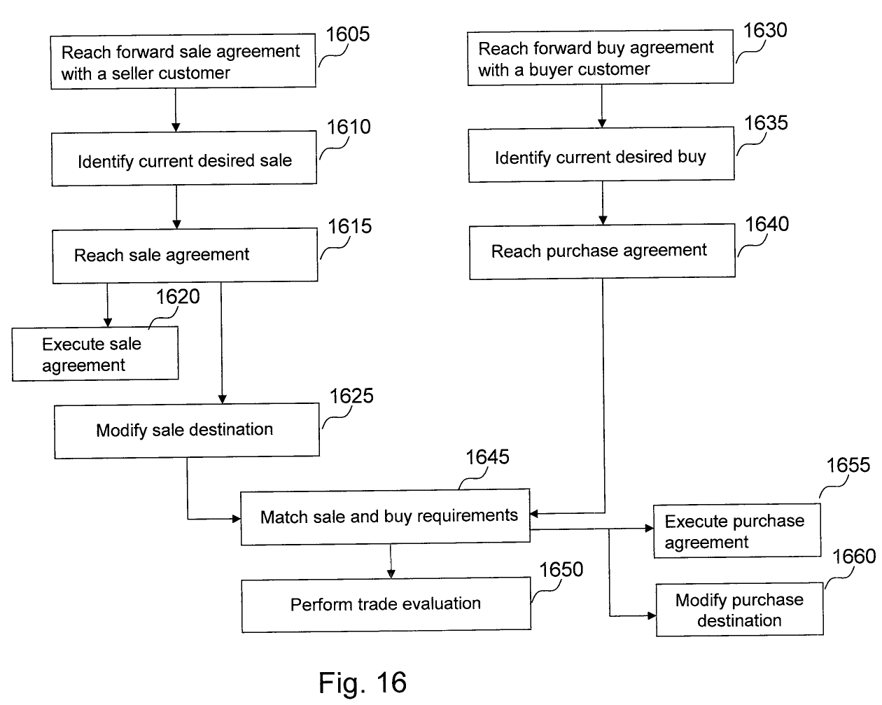

FIG. 16 illustrates the flow of achieving a bilateral transaction of goods via forward sale through two separate trades on the electronic trading platform 140, according to an embodiment of the present teaching. A seller customer and the platform operator 110 first reach, at 1605, a forward sale agreement via a first member. Under this forward sale agreement, when each time a certain quantity of goods become available, the parties identify, at 1610, the current sale under the forward sale agreement. For example, if a forward sale agreement stipulates that 500 tons of the goods contracted will be produced each month in the next 12 months, then when in a particular month the next 500 tons of goods are produced, the sale stipulated in the forward sale agreement for that particular month is now identified as current sale for actual goods under the forward sale agreement.

Once the current sale is identified, the seller customer and the platform operator 110 now reach a sale agreement, at 1615, for the current produce of the goods. This sale agreement represents the first of the two separate trades that facilitates the bilateral transaction. The first trade is then achieved by executing the sale agreement for the current sale at 1620. This includes that the platform operator 110 makes a payment for the current produce of goods and specifies, at 1625, the destination of delivery of goods to the platform operator 110. The goods delivered to the platform operator 110 is now available for any buyer to purchase via the electronic trading platform 140.

On the other hand, different buy needs are also solicited via members of the platform operator 110 from buyer customers. For example, the platform operator 110 and a buyer customer may reach, at 1630, a forward buy agreement via a second member. Such a buy forward agreement may also be rendered into individual needs for goods during different periods of time. For instance, if a buy forward agreement is for 200 tons of goods per month for the next 24 months, then for each month, there is an individual current need to 200 tons of goods. Thus, the parties may identify a current need for actual goods at 1635 for, e.g., each month. Based on such identified current need, the parties may enter into, at 1640, an individual purchase agreement for actual goods under the initial buy forward agreement for the current need. Once such a current purchase agreement is entered into, such a need is registered with the electronic trading system as goods needed and can be matched against any goods available for the purpose of buying.

With both goods available and goods needed now registered as inventories of the electronic trading platform 140, a match can be found, at 1645, as to the goods available and the goods needed. As discussed herein, a match can be found by split or merge. In the given examples, the particular goods available is 500 tons (for a particular month) and the particular goods needed is 200 tons (for a particular month). In this case, to find a match, the goods available may be split into two portions, one is 200 tons and the other is 300 tons. This can also be applied to the goods needed in the similar manner to facilitate a match.

Since each inventory (either goods available or goods needed) is associated with some members. Therefore, a match is also between members. In some situations, the match can be between the first and the second members. In some situations, the first member may be the same as the second member. However, in most situations, they are not the same. In addition, as discussed herein, before a match is found, members associated with the goods (whether available or needed) may have changed due to trades among members. Therefore, it is possible that a match found is between neither the first member nor the second member.

As discussed herein, using the electronic trading platform 140, there are two separate trades to facilitate one conventional bilateral transaction of goods. The first trade, as mentioned above, is the trade between the seller customer and the platform operator 110. The second trade is the one based on the match of goods available (at the platform operator 110) and goods needed (also at the platform operator 110). This second trade is achieved at 1655 by executing a purchase agreement based on the match. Upon entering into the purchase agreement from the match, the destination where the traded goods is to be delivered is further modified, at 1660, to where the buyer customer specifies. In addition, information associated with the second trade based on the match is used to perform trade evaluation at 1650. As discussed herein, such trade information analysis may further affect the index price used for trades performed via the electronic trading platform 140 and/or other strategic decisions made by the platform operator 110.

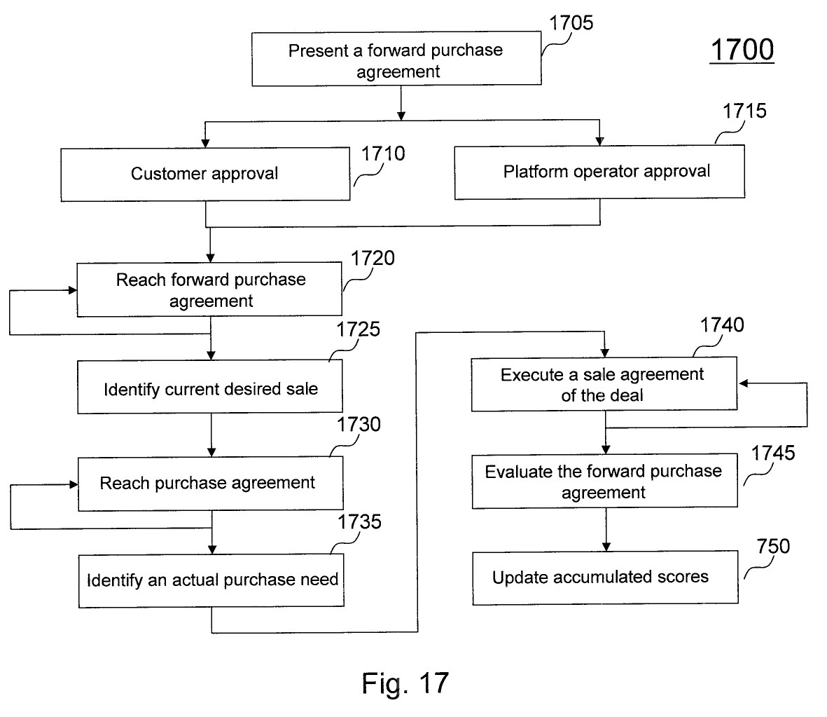

FIG. 17 is a flowchart of an exemplary process of trading via forward sale agreement using the electronic trading platform 140, according to an embodiment of the present teaching. A forward sale agreement is first presented, at 1705, to both the seller customer and the platform operator 110. To proceed, both the seller customer and the platform operator 110 approve, at 1710 and 1715, the forward sale agreement, before the parties reach the forward sale agreement at 1720. Such a forward sale agreement may be further traded among members, as indicated by the self-looping arrow so that different forward sale agreements may be reached each time it is traded.

A forward sale agreement can be converted into a sale agreement for actual goods. To achieve that, a current need for selling goods is identified at 1725. With the current need for selling goods identified, a sale agreement for actual goods can be reached at 1730. As discussed herein, such a sale agreement can be further traded among members, as indicated by the self-looping arrow. For each trade of the sale agreement, a different sale agreement may be entered with different terms (e.g., price) and an exchange of fees may occur at the same time. To actually sell the products, the member who is associated with the goods to be sold identifies, at 1735, an actual need from another member associated with a buyer customer for buying the goods. This is a matching process and may involve transformation such as split, as discussed herein. Once a match is found, a sale agreement between the platform operator 110 and the buyer customer is executed at 1740 to conclude the deal.

As a part of the system operation of the electronic trading platform 140, the concluded trade is evaluated, at 1745, with respect to the forward sale agreement. For example, if a forward sale agreement relates to selling 200 tons of goods per month for 12 months, then when goods for each month is sold, an evaluation is performed towards the forward sale agreement. Such evaluation may be accumulative due to the nature of the forward sale. Based on such evaluation, the scores or points associated with the member(s) associated the forward sale agreement may also be updated at 1750. There can be a variety of approaches to evaluate the scores or points associated with the sale agreement. In addition, different approaches of accumulating such scores or points may be applied to different members who are associated with the forward sale agreement. For example, the member who is the first member in a downstream trades of the forward sale agreement may be evaluated differently from all other members who are in the downstream trades.

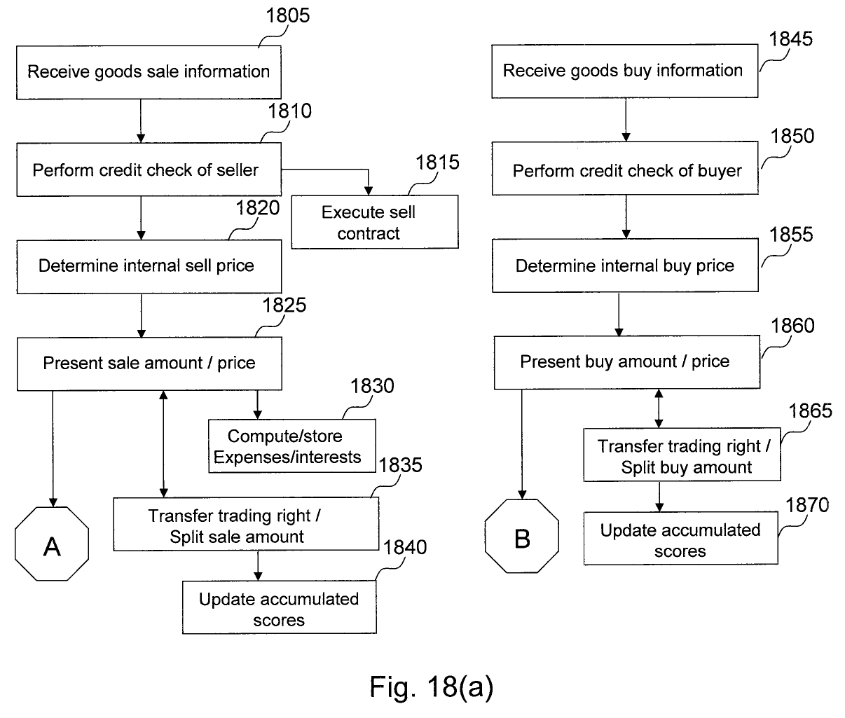

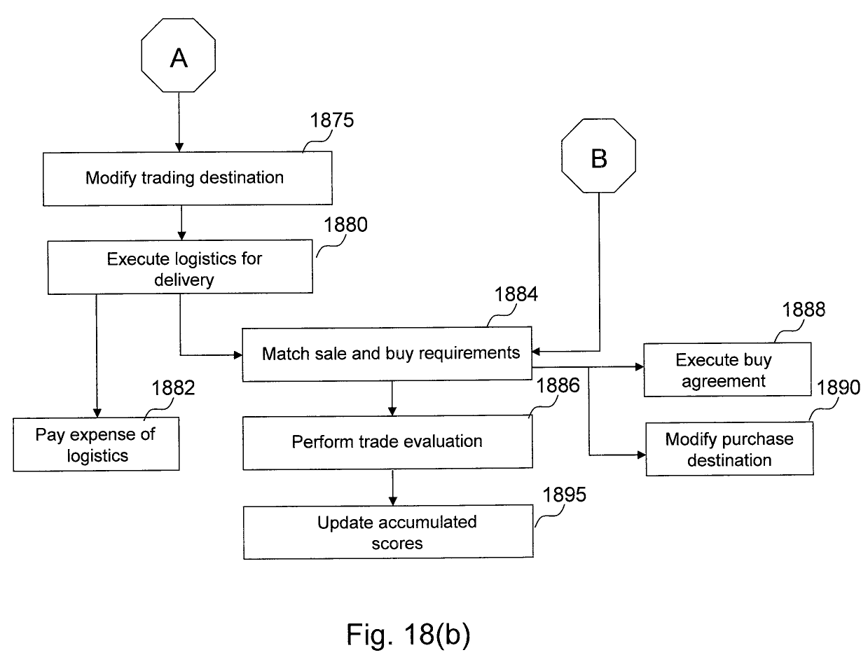

FIGS. 18(a) and 18(b) is a flowchart of an exemplary process in which a sale of goods is accomplished via two separate trades, according to an embodiment of the present teaching. Similar to what is illustrated in FIG. 16, first to complete a first trade, information related to goods to be sold is first received by the platform operator 110 at 1805. Based on the information, the platform operator 110 performs a credit check on the seller customer at 1810. Upon passing the credit check, the platform operator 110 and the seller customer execute, at 1815, a sell contract for goods offered by the seller customer. The sale agreement is entered into via a first member of the platform operator 110. Upon executing the sell contract, the platform operator 110 purchases the goods from the seller customer and stock the goods in its inventory.

Upon having the goods in the inventory, the first member who has the right to trade may then start to trade the goods with other member(s) who need to purchase the same type of goods on behalf of some buyer customer(s). To do so, the first member determines, at 1820, an internal sell price for the goods. Such an internal price usually differs from the price at which the platform operator 110 purchased the goods. It is the difference between the purchase price at which the platform operator 110 buys the goods and the price the first member trade the goods that gives the first member a gain or commission like may be the selling price that determines a gain to the first member. If the first member sells the goods to a second member who buys on behalf of a buyer customer at an actual selling price, the gain to the first member may be based on the difference between the purchase price and the selling price. In the meantime, the second member may also receive a gain if the actual selling price is lower than a buying price that the second member quoted to the buyer customer. However, if the first member transfer his right to trade the goods to another member at an internal price, then the gain to the first member may be based on a gain agreed between the first and the other member, which may be computed based on the difference between the purchase price and the internal price. Similarly, if the second member transfers his right to buy the goods at a quoted price to a different member for a gain, the gain to the second member associated with the right to trade may be computed based on the difference between the quote buying price and the internal buying price offered by the member who receives the right to buy the goods.

Once the internal sell price is determined, the inventory is presented, at 1825, via the electronic trading platform 140 to all members. With such inventory available, the electronic trading platform 140 starts to compute, at 1830, expenses incurred to maintain the inventory, which may include the expenses to store the goods or any interests incurred due to maintaining the goods. Once the inventory is presented, some internal trades may occur at 1835. Such trades may be transfer of right to trade or any split sale of the goods available. When certain internal trade occurs, the accumulated scores/points associated with the members involved in the underlying trade may be updated at 1840. On the other hand, when goods is purchased, the destination where the goods is to be delivered from the seller customer to the platform operator 110 is specified at 1875. Once this is specified, appropriate logistics for deliver the goods are executed at 1880. Upon executing the logistics, payment for such delivery is paid at 1882.

As discussed herein, to sell goods from a seller customer to a buyer customer, two separate trades are needed. The first trade is between the seller customer and the platform operator 110. The second trade is between the platform operator 110 and a buyer customer. To that end, the platform operator 110 receives, at 1845 via a buyer member, information associated with a buyer customer who desires to purchase goods. The received information may include the information about the buyer customer, the goods need to be purchased, the quantity and the purchase price. With the received information, the platform operator 110 or the buyer member performs a credit check, at 1850, on the buyer customer. If the credit check passes, the platform operator 110 accepts the offer to buy the specified goods at the purchase price. At that point, an internal purchase price is determined at 1855 and the inventory (goods needed) is presented, at 1860, to all members at the electronic trading platform 140.

Once the goods needed inventory is presented, some internal trades may occur at 1865. Such trades may be transfer of right to trade or any split purchase of the goods needed. When certain internal trade occurs, the accumulated scores/points associated with the members involved in the underlying trade may be updated at 1870. To buy the goods needed, a match between the goods available and the goods needed are matched, at 1884, via the electronic trading platform 140. Such a match may be between a split goods available or a split goods needed. When such a match is identified, the original sale agreement for goods is executed at 1888 between the platform operator 110 and the buyer customer via a member who has the right to trade the goods needed at the time of the agreement. In addition, the destination where the goods traded under this new sale agreement is modified at 1890 so that the goods can be delivered to the buyer customer to conclude the sale. Furthermore, the underlying trade is evaluated at 1886 and based on such an evaluation, various scores/points associated with members or customers are updated at 1895.

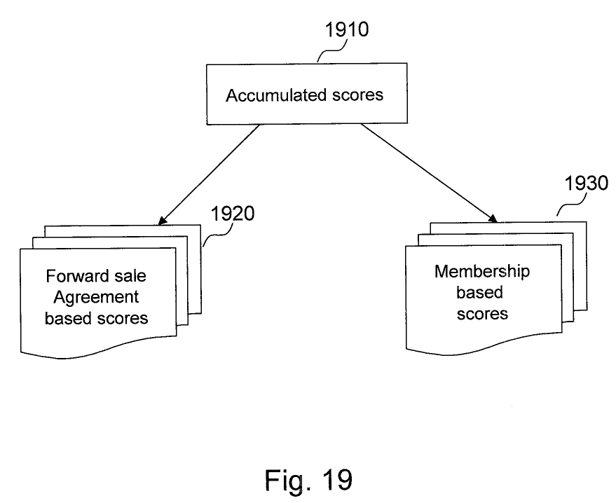

FIGS. 19 illustrates exemplary types of scores/points 1910 that may be accumulated within the electronic trading platform 140, according to an embodiment of the present teaching. As shown, there are two exemplary types of scores/points that the electronic trading platform 140 may accumulate. One is scores/points accumulated based on evaluation on forward sale agreements 1920. The other is scores/points accumulated based on memberships 1930. Other types of scores/points may be accumulated under the general operational scheme of the electronic trading platform 140. As one ordinary skilled in the art would understand, such difference does not deviate from the spirit of the present teaching.

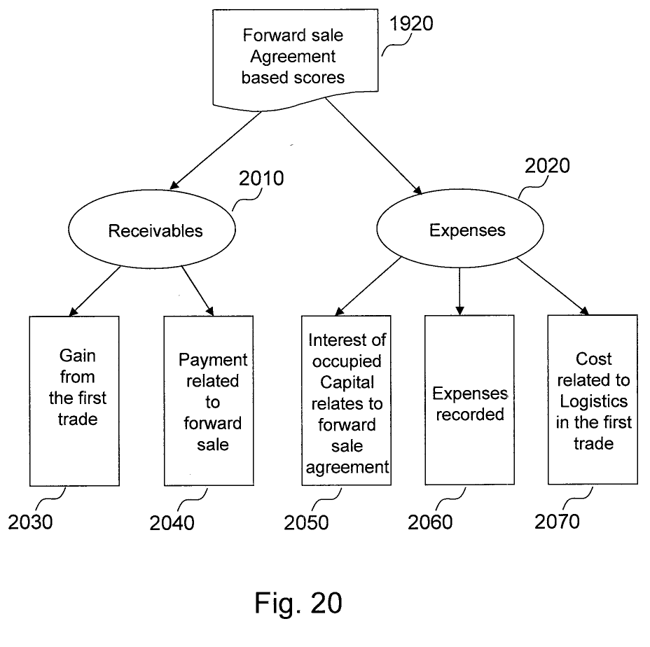

FIG. 20 illustrates exemplary types of considerations when scores/points based on forward sale agreements are accumulated, according to an embodiment of the present teaching. In general, there are two exemplary categories of considerations due to the nature of a forward sale agreement. The first exemplary category is related to receivables 2010 and the other relates to expenses 2020. Under the category of receivables 2010, a gain 2030 yielded from the first trade in which the right to trade is transferred from a member who is initially involved in the underlying forward sale agreement with a seller customer to another member. In addition, under receivables 2010, the payment 2040 related to a forward sale is also considered as receivables. Under the category of expenses 2020, interests 2050 associated with capitals vested in the forward sale agreement is considered as an expense and that may need to be deducted from the gains in accumulation of scores or points. Such deduction may be in full amount or in partial amount. Similarly, any expenses 2060 recorded in association with the forward sale agreement is also considered. Furthermore, any costs 2070 related to logistics in the first trade, as discussed above, is also considered as an expense for the purpose of evaluating accumulated scores/points.

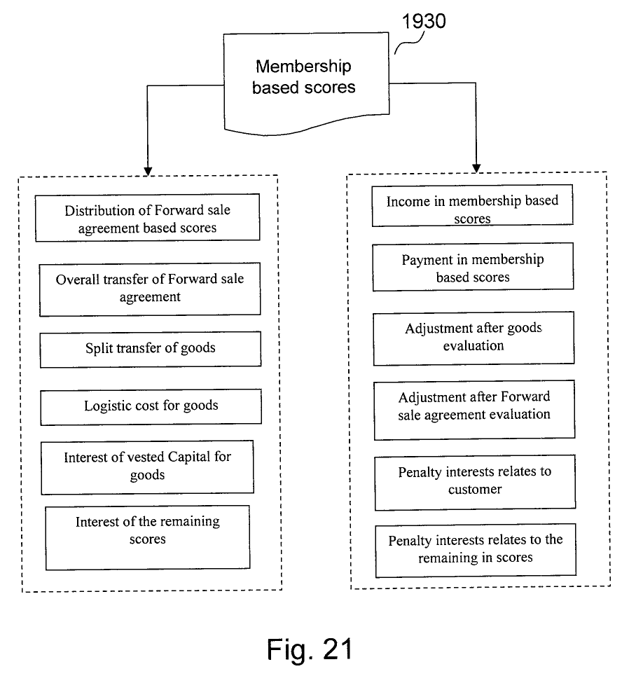

FIG. 21 illustrates exemplary types of considerations when the membership based scores 1930 are to be accumulated, according to an embodiment of the present teaching. There are may be different categories of considerations. For example, the distribution of forward sale related scores, transfer of overall forward sales, split transfer of goods, costs related to logistics for goods, interests associated with vested capital for goods, interests related to the remaining scores, income from membership based accumulated scores, payment related to membership based accumulated scores, adjustment made after goods evaluation, adjustment made after forward sale agreement, penalty interests related to customers, and penalty interests related to the remaining scored. Other factors may also be put into consideration for membership based accumulated score evaluation. In addition, different considerations may be related to each other and the evaluation may be performed based on certain relationships existing among different factors.

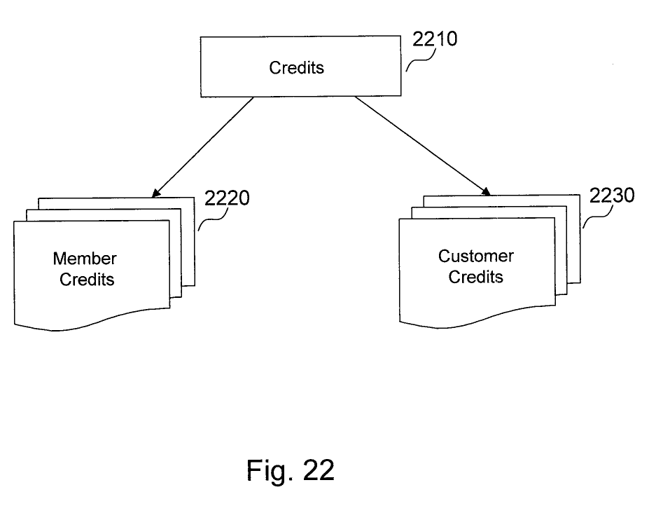

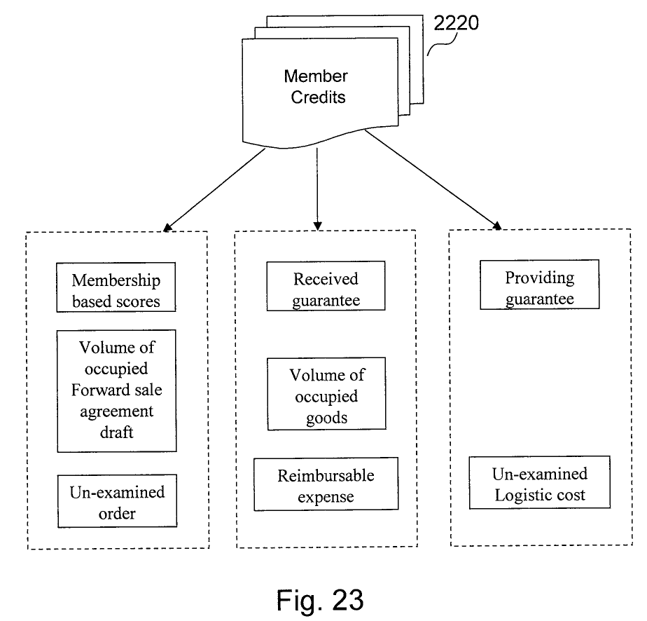

FIG. 22 illustrates exemplary types of credits 2210 that can be accumulated, according to an exemplary embodiment of the present teaching. The first illustrated exemplary type of credit is member credits 2220 and the second type if customer credits 2230. FIG. 23 presents exemplary types of considerations that may contribute to an evaluation of member credits. For instance, membership based accumulated scores/points of a member may be considered in evaluating the credit of the same member. The number of forward sale agreement drafts under the member may also be a consideration. The higher the number, the higher the credit of the member may be. However, this may be evaluated in light of a balancing factor, e.g., the number of un-examined order for the goods covered under the forward sale agreement. For instance, even with a high forward sale agreement, if the actual order remains low, this may be counted against the high credit assigned to the member due to a higher volume of the forward sale agreement.

In addition, if there is a received guarantee, the credit of the member may be improved. On the other hand, if the member is required to provide a guarantee, the credit may be lowered. Similarly, if the volume of occupied goods is high, it may also affect the accumulated credit of the member. Furthermore, reimbursable expenses may be counted in favor of credit accumulated because, e.g., there will be more cash available for trade. If there is a cost for logistics that have yet to be approved, it can be counted unfavorably for the purpose of accumulating credit.

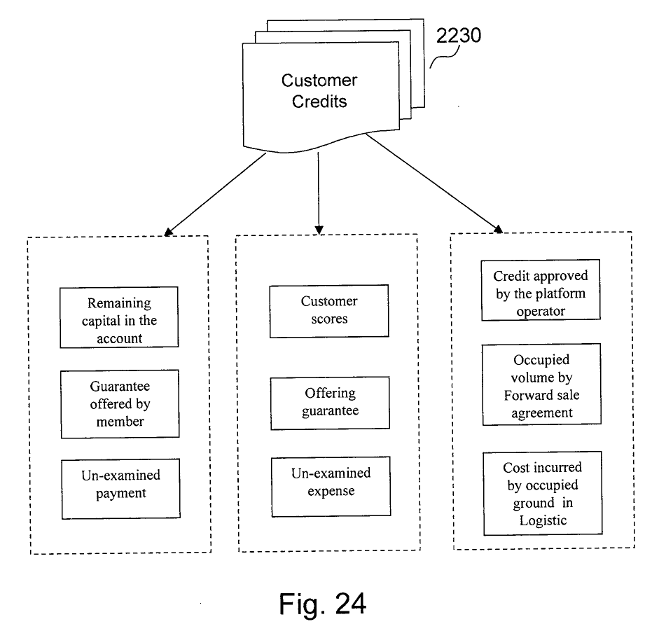

FIG. 24 presents exemplary types of considerations that may contribute to an evaluation of customer credits 2230. First, remaining amount of capital in the customer's account is to be considered. A guarantee offered by a member of the platform operator 110 may also be counted in favor of a customer's credit. For example, if a customer does not have adequate amount of capital in the account but a member provided a guarantee for the capital needed for the customer to trade, this guarantee can be considered as a credit to the customer. Similar to member based credit, if there is an un-examined payment, available customer scores/points, credit pre-approved by the platform operator 110, or a high volume of forward sale agreement, all these can be counted in favor of the customer for the purpose of credit accumulation. Conversely, if it is required for the customer to provide a guarantee, there is an un-examined expense incurred to the customer, or there is a cost associated with the occupied ground related to the logistics, these factors may be considered against the credit accumulation of the customer. These discussed considerations are merely exemplary. Factors to be considered in evaluating credits may vary and they are all within the scope of the present teaching.

While the inventions have been described with reference to the certain illustrated embodiments, the words that have been used herein are words of description, rather than words of limitation. Changes may be made, within the purview of the appended claims, without departing from the scope and spirit of the invention in its aspects. Although the inventions have been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

I claim:

1. A method for facilitating a seller to trade goods with a buyer via a network-based electronic trading platform, comprising:
responding to a first request from a seller customer to a first member of a platform operator to sell goods, performing a first action via an electronic trading platform connected to a network, facilitating the platform operator and the seller customer to enter into a first agreement to enable the platform operator to purchase the goods via the first member at a first price;
assigning the property ownership of the purchased goods to the platform operator and a right to trade the purchased goods to the first member;
responding to a second request from a buyer customer to a second member of the platform operator to buy a certain quantity of the goods, performing a second action via the electronic trading platform, facilitating the platform operator and the buyer customer to enter into a second agreement enabling the buyer customer to buy the certain quantity of the goods from the platform operator via the second member at a second price;
assigning a right to buy the certain quantity of the goods to the second member;
facilitating, via the network-based electronic trading platform, a match between a need for the certain quantity of the goods at the second price and goods owned by the platform operator; and
responding to the match, performing a third action facilitating the platform operator to sell the certain quantity of the goods to the buyer customer based on the second agreement.

2. The method according to claim 1, wherein the first agreement is one of a forward sale agreement and a conventional sale agreement for the product.

3. The method according to claim 2, wherein the first agreement includes a term related to delivering the purchased goods, when due, from the seller customer to a destination specified by the platform operator.

4. The method according to claim 1, wherein a second agreement is one of a forward sale agreement and a conventional sale agreement for goods.

5. The method according to claim 4, wherein the second agreement includes a term related to delivering the certain quantity of the goods from the platform operator to a destination required by the buyer customer.

6. The method according to claim 1, wherein the right to trade the purchased goods includes a right to sell the purchased goods and a right to transfer the right to trade from one member of the platform operator to another member of the platform operator.

7. The method according to claim 1, wherein the right to purchase includes a right to buy the certain quantity of the goods and a right to transfer the right to purchase from one member of the platform operator to a different member of the platform operator.

8. The method according to claim 6 or 7, wherein the transfer of the right to trade or the right to purchase can be achieved with a gain to a transferring member who initiates the transfer paid by a receiving member who receives the transferred right.

9. The method according to claim 8, wherein the gain is computed based on a difference between a previous price used by the transferring member and a current price accepted by the receiving member.

10. The method according to claim 1, wherein the first member splits the purchased goods into a plurality of groups, each of which has an associated quantity and a price.

11. The method according to claim 10, wherein the first member:
transfers the right to trade associated with each group to another member of the platform operator; or
sells goods within each group at a price associated therewith.

12. The method according to claim 1, wherein the certain quantity of the goods needs includes a plurality of groups of the goods needs, each of which is associated with a member of the platform operator who has the right to buy goods corresponding to that group.

13. The method according to claim 1, wherein from the first agreement to the sale of the certain quantity of the goods to the buyer customer, there is a conversion from a forward sale agreement involving anticipated product sale to a sale agreement involving actual product sale.

14. The method according to claim 1, wherein said performing the first action comprises:
collecting, via the electronic trading platform, information associated the goods to be sold by the seller customer and information related to the seller customer;
analyzing, on the electronic trading platform, the information collected;
performing authorization of the purchase;
upon being authorized, entering into the first agreement with the seller customer.

15. The method according to claim 14, wherein the authorization includes checking the credit of the seller customer.

16. The method according to claim 14, further comprising specifying, by the platform operator, a destination where the purchased goods are to be delivered from the seller customer to the platform operator.

17. The method according to claim 1, wherein said performing the second action comprises:
collecting, via the electronic trading platform, information associated the goods to be bought for the buyer customer and information related to the buyer customer;
analyzing, on the electronic trading platform, the information collected;
performing authorization of the sale;
upon being authorized, entering into the second agreement with the buyer customer.

18. The method according to claim 17, further comprising specifying, by the buyer customer, a destination where the certain quantity of the goods is to be delivered.

19. The method according to claim 1, wherein said facilitating a match comprises:
dynamically categorizing goods purchased by the platform operator as goods available;
dynamically categorizing goods in need by one or more buyer customers as goods needed;
presenting goods available and goods needed in a manner to facilitate search;
matching the goods needed with goods available.

20. The method according to claim 19, wherein said matching includes:
matching the need for the certain quantity of the goods at the second price with goods available; or
matching the purchased goods at the first price with goods needed.

21. The method according to claim 20, wherein said matching the need comprises:
identifying at least one enlisted goods available that is compatible with the need;
registering the at least one enlisted goods available with the need listed; and
removing the at least one enlisted goods available from the goods available.

22. The method according to claim 20, wherein said matching the purchased goods comprises:
identifying at least one enlisted goods needed that is compatible with the purchased goods;
registering the at least one enlisted goods needed with the purchased goods; and
removing the at least one enlisted goods needed from the goods needed.

23. The method according to claim 1, wherein said performing the third action comprises:
identifying one or more destinations to where the goods is to be delivered;
performing logistics arrangement based on the one or more destinations and in accordance with delivery vendor information retrieved from the electronic trading platform;
executing the logistics arrangement;
monitoring scheduled delivery and account receivable;
performing trading evaluation based on the results from the monitoring; and
updating accumulated scores for relevant parties based on the trading evaluation.

24. The method according to claim 23, wherein said performing logistics arrangement comprises:
identifying at least one delivery vendor available for the delivery based on credit associated with each vendor;
allocating qualified vendors to different routes required for the delivery; and
designating a party, for each allocated vendor for the delivery, for verifying the completion of the designated delivery.

25. The method according to claim 24, wherein the party for verifying includes at least one of a third party service provider, the vendor allocated, and the buyer customer.

26. The method according to claim 23, wherein said monitoring comprises:
monitoring the outcome of each delivery vendor assigned;
monitoring the quality issue associated with the purchased goods from the seller customer;
monitoring the payment issue associated with the buyer customer; and
recording the monitored information in a categorized manner.

27. The method according to claim 23, wherein said performing trading evaluation comprises:
analyzing information related to the scheduled delivery and the account receivable;
analyzing the profit margin yielded from the trade;
updating a credit associated with each delivery vendor based on the analysis of the information associated with the scheduled delivery;
updating a credit associated with the seller customer based on the profit margin; and
updating a credit associated with the buyer customer based on the profit margin and the analysis of the information associated with the account receivable.

28. The method according to claim 1, wherein said first and second price are consistent with an index established in accordance with trading policies determined by the platform operator.

29. A system for facilitating a seller to trade goods with a buyer on a network-based electronic trading platform, comprising:
a trading control platform, connected to a network, including:
a buy trade processor configured for performing, as a response to a first request from a seller customer to a first member of a platform operator to sell goods, a first action facilitating the platform operator and the seller customer to enter into a first agreement to enable the platform operator to purchase the goods via the first member at a first price,
a sell trade processor configured for performing, as a response to a second request from a buyer customer to a second member of the platform operator to buy a certain quantity of the goods, a second action facilitating the platform operator and the buyer customer to enter into a second agreement enabling the buyer customer to buy the certain quantity of the goods from the platform operator via the second member at a second price,
a matching processor configured for facilitating a match between a need for the certain quantity of the goods at the second price and goods owned by the platform operator, and
a bilateral processor configured for performing, responding to the match, a third action facilitating the platform operator to sell the certain quantity of the goods to the buyer customer based on the second agreement;
a service support system configured for
assigning the property ownership of the purchased goods to the platform operator and a right to trade the purchased goods to the first member, and
assigning a right to buy the certain quantity of the goods to the second member.
